(19) United States
(12) Patent Application Publication
(10) Pub. No.: US 2018/0308326 A1
(43) Pub. Date: Oct. 25, 2018

(54) DIGITAL SMART SAFETY SYSTEM, METHOD, AND PROGRAM

(71) Applicant: TECHNOMIRAI CO., LTD., Tokyo (JP)

(72) Inventor: Kazuo Miwa, Tokyo (JP)

(21) Appl. No.: 15/771,068

(22) PCT Filed: May 16, 2016
(86) PCT No.: PCT/JP2016/064462

§ 371 Date: Apr. 25, 2018

(30) Foreign Application Priority Data
Oct. 29, 2015 (JP) PCT/JP2015/080620

(51) Int. Cl. G08B 7/06; G08B 17/10; G08B 13/22

(52) U.S. Cl. CPC G08B 7/066; G06K 9/00288; G08B 13/22; G08B 17/10

(57) ABSTRACT

Provided are a digital smart safety system, method, and program capable of safely guiding evacuation of people in a facility in case of fire. A digital smart safety system (1000) comprises a smoke determination means (112) that determines a flow direction, volume and speed of smoke based on smoke information detected by a plurality of smoke detection means (234), an air blower that is installed at a smoke diffusion spot including openings such as windows or smoke vents around the exterior, and sets an air blowing direction based on results of determination by the smoke determination means, a fire door detection means (113) that detects that a fire door/fire shutter (228) installed in the facility is not closed, a human detection means (114) that detects a person who has failed to escape in case of fire, and a control means (115) that designates a safe place based on results of determination by the smoke determination means (112) and performs evacuation guidance control to guide evacuation of a person relevant to the facility.

### TECHNICAL FIELD

The present invention relates to a digital smart safety system, method, and program that monitor the status of a facility by taking-in information from a safety-related device installed in the facility, and safely guides evacuation of persons relevant to the facility from a fire or a suspicious person.

### BACKGROUND ART

Scale expansion and concentration of buildings and facilities, and making housing multistory have been increasingly promoted. For example, the sophistication and complexity of a commercial facility, a hotel, a multistoried office, a multipurpose complex building, a meeting place, a hospital, a theater, a college, a factory, a multistoried or superhigh-rise apartment building, a terminal building, an underground mall, a ship, individually owned housing, etc., are remarkable.

Measures for safety as well as convenience are extremely important, and sophisticated safety measures have been demanded. A resident population in a large-scale facility is large, so that an impact thereon from an accident, incident, or a fire is significant.

Accidents and incidents include intrusion of an intruder from the outside and information leakage by a corporate insider. As anti-crime measures against intrusion fromthe outside, double locks, security cameras, crime sensors, authentication passwords, and fingerprint authentication, etc., have been upgraded and expanded. In addition, as management of provision of information to insiders, etc., authentication cameras, RFID readers, passwords, and fingerprint authentication have been introduced.

Preventive measures such as a fire alarm, fire extinguishing equipment, and evacuation facilities, etc., are first cited as complete installations against flame, smoke, and gas, etc. In addition, evacuation drills including fire warning, fire extinguishing, and evacuation guidance, etc., are essential. However, fire accidents in which people are engulfed in flame, smoke, and gas, etc., and do not know an evacuation direction, and fail to escape have occurred.

In Patent Literature 1, fire evacuation equipment interlocked with a portable communication terminal and including an evacuation guide unit that, when receiving an evacuation guidance message, grasps a nearby evacuation exit based on a position of the portable communication terminal in a building from an electronic map showing the interior of the building, and outputs a map image and an evacuation sound to guide evacuation in an evacuation direction is described. A direction opposite to a smoke flow direction corresponds to a site of a fire, so that the evacuation guide unit guides evacuation in a flow direction of smoke that escapes from the fire site.

### CITATION LIST

### Patent Literature

[PTL 1] JP 2016-015133 A

### SUMMARY OF INVENTION

### Technical Problem

In a special building (hereinafter referred to as building facility) such as a conventional large-scale commercial facility, hospital, hotel, complex, terminal, underground mall, theater, meeting place, or ship, among firefighting equipment, as functions to discharge smoke and toxic gases, there are a mechanical smoke ventilation system and natural smoke ventilation through windows around the exterior, and particularly, for large-scale and underground building facilities, mechanical smoke ventilation is mandatory. However, in a monitoring system of these facilities, a system that informs real time status such as a fire site, a floor number and location where a person who has failed to escape stays and prevents an accident, incident, and a fire is not yet satisfactory. Incase of an event of a fire fatal to humans, to cope with smoke, toxic gas or carbon monoxide (hereinafter collectively referred to as smoke) produced by fire and intricately filling the inside of the facility at various speeds, there are legal installation standards that smoke vents in a building facility should be installed at distances not longer than 30 m from various positions inside the facility, and the standards must be observed. The smoke vents have a function to discharge smoke outdoors, however, smoke accumulates at an upper portion near the ceiling by hot air, and is not sufficiently discharged by the smoke ventilation system alone in relation to desks, display furniture, merchandise, and partitions, and smoke is filled in the room and becomes high in concentration, and visibility becomes low and a safe evacuation direction is unknown, and under present circumstances, it is difficult to accurately determine how to guide evacuation of an evacuee who is unconscious due to a toxic gas and has become unable to breathe.

An object of the present invention is to provide a digital smart safety system, method, and program capable of safely and accurately guiding evacuation of people in a facility in case of fire, particularly from smoke.

### Solution to Problem

A digital smart safety system according to the present invention comprises a safety-related information storage means that stores safety-related information including a layout of a facility; a plurality of smoke detection means that are installed in the facility and detect smoke from a fire; a smoke determination means that determines a flow direction, volume and speed of smoke based on smoke information detected by the plurality of smoke detection means; and a control means that designates a safe place based on results of determination by the smoke determination means and performs evacuation guidance control to guide evacuation of a person relevant to the facility.

With this configuration, by detecting a flow direction, volume and speed of smoke, a safe place is designated and a guidance to the safe place is given, so that high-quality evacuation guidance to guide a person in a direction with less and slower smoke flow is realized, and in case of a fire, evacuation of people in a facility can be safely and accurately guided.

The digital smart safety system comprises an air blower that is installed at a smoke diffusion spot including openings such as windows or smoke vents around the exterior, and sets an air blowing direction based on results of determination by the smoke determination means, wherein when detecting smoke from a fire or at the time of the evacuation guidance, the control means diffuses smoke by driving the air blower, and accordingly, a visual failure and a breathing problem which makes it difficult for an evacuee to evacuate due to a great force of fire and smoke filled in the building facility are prevented, and the air blower changes its air blowing direction and blows and guides smoke to an optimum smoke vent based on the direction, volume and speed of the smoke filling in the building facility, discharges the smoke outdoors, dilutes the concentration of the smoke that causes the visual failure, and therefore, an evacuee can safely and securely evacuate.

The digital smart safety system comprises a fire door detection means that detects that a fire door installed in the facility is not closed, wherein the control means reports that, based on results of detection by the fire door detection means, the fire door is not closed to a person relevant to the facility, and accordingly, the control means can take measures to prevent an evacuee from being involved in an accident due to smoke being filled while the fire door is open, and therefore, the evacuee can evacuate safely. This fire door includes a fire shutter in the present description, and the fire shutter is installed in each section not larger than 3,000 m² in the building facility.

The digital smart safety system comprises a human detection means that detects a person who has failed to escape incase of fire, wherein the control means reports the existence of the person who has failed to escape based on results of detection by the human detection means, and accordingly, the person who has failed to escape can be securely rescued or guided for evacuation.

A digital smart safety method according to the present invention comprises a safety-related information storing step of storing safety-related information including a layout of a facility; a smoke detecting step of detecting smoke from a fire, installed in the facility; a smoke determination step of determining a flow direction, volume and speed of smoke based on smoke information detected in the smoke detecting step; and a control step of performing evacuation guidance control to designate a safe place based on results of determination in the smoke determination step, and guide evacuation of a person relevant to the facility.

Also, the present invention is a program to make a computer function as a digital smart safety system comprising a safety-related information storage means that stores safety-related information including a layout of a facility, a plurality of smoke/gas detection means that are installed in the facility and detect smoke from a fire, a smoke determination means that determines a flow direction, volume and speed of smoke based on smoke information detected by the plurality of smoke detection means, and a control means that designates a safe place based on results of determination by the smoke determination means and performs evacuation guidance control to guide evacuation of a person relevant to the facility.

### Advantageous Effects of Invention

According to the present invention, in case of an event of a fire fatal to humans, evacuation of people in a facility can be safely and accurately guided based on a flow direction, volume and speed of smoke from the fire intricately filling the facility at various speeds.

In an office with ventilation equipment, a concentration of CO as a toxic gas is legally required to be 10 ppm or less.

### BRIEF DESCRIPTION OF DRAWINGS

FIG. 1 is a block diagram showing a configuration of a digital smart safety system according to an embodiment of the present invention.

FIG. 2 is a flowchart showing fire guidance control of a control unit of a monitoring device of the digital smart safety system according to the embodiment of the present invention.

FIG. 3A is a flowchart showing person registration processing of the control unit of the monitoring device of the digital smart safety system according to the embodiment of the present invention.

FIG. 3B is a flowchart showing Wi-Fi authentication registration processing of the control unit of the monitoring device of the digital smart safety system according to the embodiment of the present invention.

FIG. 3C is a flowchart showing iBeacon registration processing of the control unit of the monitoring device of the digital smart safety system according to the embodiment of the present invention.

FIG. 3D is a flowchart showing RFID authentication registration processing of the control unit of the monitoring device of the digital smart safety system according to the embodiment of the present invention.

FIG. 4 is a flowchart showing evacuation guidance control processing of the monitoring device of the digital smart safety system.

FIG. 5 shows a subroutine showing suspicious person determination processing of the monitoring device of the digital smart safety system according to the embodiment of the present invention.

FIG. 6A is a flowchart showing mode-response control processing of the monitoring device of the digital smart safety system according to the embodiment of the present invention.

FIG. 6B is a flowchart showing mode-response control processing of the monitoring device of the digital smart safety system according to the embodiment of the present invention.

FIG. 7 is a view showing an upper-floor layout of a commercial facility in case of fire, to which the digital smart safety system according to the embodiment of the present invention is applied.

FIG. 8 is a view showing an upper-floor layout of a commercial facility in case of fire, to which the digital smart safety system according to the embodiment of the present invention is applied.

FIG. 9 is a view showing a 1st-floor layout of a commercial facility to which the digital smart safety system according to the embodiment of the present invention is applied.

FIG. 10 is a view showing an example of an office or a research and development office to which the digital smart safety system according to the embodiment of the present invention is applied.

### DESCRIPTION OF EMBODIMENTS

Hereinafter, an embodiment to carry out the present invention is described in detail with reference to the accompanying drawings.

### Embodiment

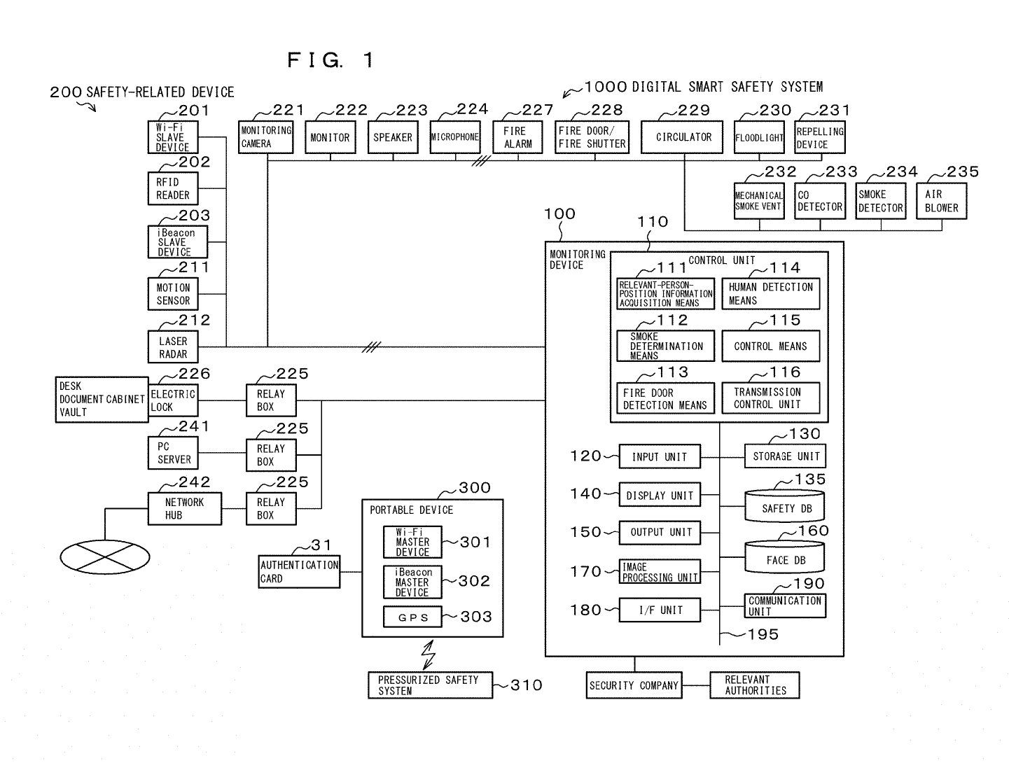

FIG. 1 is ablockdiagramshowing a configurationof adigital smart safety system according to an embodiment of the present invention.

The present embodiment is an application example to a digital smart safety system that monitors the status of a facility by taking-in information from a safety-related device installed in the facility, and transmits information to a portable device that a person relevant to the facility carries with him/her. Incidents and accidents include a fire and a suspicious person, etc.

In case of fire, many fatal accidents occur due to breathing difficulties caused by inhalation of smoke. Smoke is a kind of aerosols, and a mass of air containing particles produced as a result of incomplete combustion.

A suspicious person is an intruder from outside of a company, an in-company relevant person who works outside of a permitted time, an in-company relevant person being in an area outside of a permitted work area, etc.

As shown in FIG. 1, a digital smart safety system 1000 comprises a monitoring device 100 that controls the whole system, various kinds of safety-related devices 200 installed in building facilities such as a business facility, a commercial facility, a work facility, an office, a research and development office, and a factory, etc. , and portable devices 300 that persons relevant to the business facility, commercial facility, work facility, office, research and development office, and factory, etc., carry with them.

The digital smart safety system 1000 is a system that monitors the status of a facility by taking-in information from a safety-related device installed in the facility, displays necessary information, and transmits information to portable devices that persons relevant to the facility carry with them.

[Monitoring Device 100]

The monitoring device 100 is a PC server that centrally manages the inside of the business facility or a work PC server that promotes work, installed in, for example, a management room of a business facility. The monitoring device 100 may be installed as a functional unit to perform digital smart safety control in the PC server or work PC server, or installed alone. The monitoring device 100 maybe a general server calculator, a personal computer, etc. In addition, the monitoring device 100 comprises an external storage device (not shown), and is connected to a network (not shown). In the external storage device that the work PC server comprises, information related to work of the work PC server is backed up.

The monitoring device 100 comprises a control unit 110, an input unit 120, a storage unit 130, a safety-related information storage database (DB) 135 (safety-related information storage means, corresponding mode storage means), a display unit 140, an output unit 150, a face information database (DB) 160, an image processing unit 170, an interface (I/F) unit 180, and a communication unit 190, and each unit is connected by a bus 195.

In a case where the appearance of a person who is a suspicious person outside the company or in-company at a store is detected, the monitoring device 100 notifies headquarters/head office and a security company system of information on this person and store information through the network.

Hereinafter, describing “. . . means” as a subject shall mean that the control unit 110 reads out each program from a ROM as necessary and then loads it on a RAM to execute each function (described below). Each program may be stored in advance in the storage unit 130, or may be taken into the monitoring device 100 via another storage medium or communication medium when necessary.

The control unit 110 consists of a CPU (Central Processing Unit), etc., and controls the whole monitoring device 100 and executes a monitoring program to make it function as the digital smart safety system.

The control unit 110 comprises a relevant-person-position information acquisition means 111 that acquires position information of portable devices that a plurality of relevant persons respectively carry with them, a smoke determination means 112 that determines a flow direction, volume and speed of smoke based on smoke information detected by a plurality of smoke detectors 234 installed at various positions in the facility, a fire door detection means 113 that detects that a fire door/fire shutter 228 installed in the facility is not closed, a human detection means 114 that detects a person who has failed to escape in case of fire, a control means 115 that performs evacuation guidance control to designate a safe place and guide evacuation of persons relevant to the facility, and a transmission control unit 116.

The control means 115 drives an air blower 23 (described below) to diffuse smoke when detecting smoke or at the time of evacuation guidance in case of fire.

The control means 115 reports that the fire door 228 (described below) is not closed to the persons relevant to the facility based on results of detection by the fire door detection means 113.

The control means 115 makes a report to a person who has failed to escape based on results of detection by the human detection means (by using Wi-Fi and RFID. Details of Wi-Fi and RFID are described below).

The control means broadcasts information on evacuation guidance to an evacuation spot on a monitor 222 and notifies it by a speaker 223, and transmits the information to the portable devices 300 of relevant persons. Also, the control means 115 transmits suspicious person information and/or safety-related information to the portable devices 300 of the relevant persons. The control means 115 performs at least any one of evacuation guidance controls including locking of crime prevention devices of the safety-related device 200, shutdown or power-off of information access devices such as the PC server, etc., and warning by an image or sound.

The input unit 120 is an input device including a keyboard, a mouse, a touch panel provided on a screen of the display unit 140, and a microphone 224, etc., to be used by a user of the monitoring device 100 to input commands, etc., into the monitoring device 100.

The storage unit 130 stores still images and moving images received from monitoring cameras 221 and various data and programs to be used by the control unit 110.

The safety-related information storage DB 135 stores safety-related information including a layout of the facility. The safety-related information storage DB 135 stores installation locations of the smoke detectors 234 (described below) together with layout information.

In addition, the safety-related information storage DB 135 stores Wi-Fi authentication registration information and iBeacon (registered trademark) registration information. The safety-related information storage DB 135 stores a plurality of response patterns according to severity levels of emergencies that may occur in the facility, as n-th-order modes (n is an integer not smaller than 2).

The display unit 140 displays operating conditions of the monitoring device 100, images received from monitoring cameras 221, and GUI (Graphical User Interface) to operate the monitoring device 100, etc.

The output unit 150 is, for example, an audio interface, and outputs a sound signal from the monitoring device 100 to a speaker 223 in the facility. A sound signal to be output from the monitoring device 100 to the speaker 223 may be a sound signal input from a sound input device, for example, the microphone 224 provided in the input unit 120, or a sound signal played by reading out sound data (sound sample data) stored in the storage unit 130 by the control unit 110. The speaker 223 comprises an amplifier and a loudspeaker disposed in the facility, and broadcasts a sound signal input from the monitoring device 100 to the interior of the facility.

The face information DB 160 accumulates facial images (face information) of suspicious persons and facility relevant persons, etc.

The image processing unit 170 applies predetermined processing to a received image. Predetermined processing includes outline extraction, image resizing, and resolution conversion, etc. In addition, the image processing unit 170 applies image processing such as addition of a red frame or yellow frame to a facial image to be transmitted to the portable devices 300 of the relevant persons.

The I/F unit 180 connects each monitoring camera 221 disposed inside the facility and the monitoring device 100. In addition, the I/F unit 180 connects the monitoring device 100 and respective RFID (Radio Frequency Identification) readers 202 disposed inside the facility and transmits results of authentication of RFID tags (authentication cards 31 in the present embodiment) that relevant persons near the RFID readers 202 carry with them to the monitoring device 100. In addition, the I/F unit 180 is connected to headquarters/head office and a security company (not shown) by a network or a dedicated line. Basic data such as faces of persons registered in the face information DB 160 are acquired from the headquarters/head office and the security company, etc., (not shown), via the I/F unit 180, and the face information DB 160 is thereby constructed. Exchanging information with the headquarters/head office and security company, etc., (not shown) can update each other's face information DBs to ones of the latest facial images (face information). In addition, the security company is not an essential structural element of the digital smart safety system 1000 according to the present embodiment.

The communication unit 190 transmits and receives data to and from the portable device 300 via a base station. In the present embodiment, the communication unit 190 receives position information of each portable device 300 via abase station periodically, and transmits information on a suspicious person (transmits an e-mail or video including a moving image, etc.) to each portable device 300 when recognizing the suspicious person.

[Safety-Related Device 200]

The safety-related device 200 comprises a Wi-Fi (Wireless Fidelity) terminal (hereinafter referred to as Wi-Fi slave device) 201, an RFID reader 202, an iBeacon slave device 203, a motion sensor 211, a laser radar 212, a monitoring camera 221, a monitor 222, a speaker 223, a microphone 224, a relay box 225, an electric lock 226, a fire alarm 227, a fire door/fire shutter 228, a circulator (hereinafter also referred to as air blower) 229, a floodlight 230, a repelling device 231, a mechanical smoke vent 232, a carbon oxide (hereinafter referred to as CO) detector 233, a plurality of smoke detectors 234 that detect smoke in case of fire, and an air blower 235 that diffuses smoke. An additional mechanical smoke vent 232 maybe installed at an arbitrary position between the mechanical smoke vents 232.

The iBeacon slave device 203 stands by in the background by executing an application with an iBeacon function, and excites a predetermined action when coming close to an iBeacon master device 302 described below of the portable device 300. The iBeacon slave device can detect position information of the iBeacon master device 302.

The motion sensor 211 is a sensor to detect a location of a human. It uses infrared rays, ultrasonic waves, and visible light, etc.

The laser radar 212 measures a size, position, and speed of an object, and detects intrusion and traverse of a suspicious person. The laser radar 212 is installed in each of important security sections such as an office, a design room, a research and development room, and a management room, etc. In addition, the laser radar is also installed at an entrance/exit of a building to which people do not usually enter.

The monitor 222 maybe a television screen or an LED display.

The relay box 225 blocks power supply paths to the electric lock 226, the PC server 241, a network hub 242, and an external storage device (not shown) in response to an OFF signal from the monitoring device 100. The electric lock 226 is installed at a desk, a document cabinet, and a vault, etc.

The repelling device 231 repels a suspicious person by a special high-frequency wave or an ear-splitting siren.

A part or all of the monitoring cameras 221 is a PTZ camera having a PTZ (pan/tilt/zoom) function, and is remotely operated by the monitoring device 100. The monitoring camera 221 is installed at each point in a monitoring target area such as a backyard facility as an area including a truck yard that those other than relevant persons are prohibited from entering, and shoots the monitoring target area. Also, the monitoring camera 221 is a camera for authentication to shoot a face of a person. An image shot by the monitoring camera 221 is output to the monitoring device 100. The monitoring camera 221 may always shoot a moving image or shoot a still image at regular intervals (for example, every several seconds).

The RFID reader 202 exchanges data with RFID tags (authentication cards 31) that the relevant persons carry by short-distance wireless communication in a non-contact manner. A communication receivable distance with the RFID tag is, for example, 3 to 7 meters. In the present embodiment, the RFID reader 202 is an RFID tag-compatible handy terminal or reader/writer. Generally, the RFID reader 202 manages the settlement, etc., of merchandise with an RF tag by detecting whether there is an answer-back in response to a transmission to the RF tag attached to the merchandise.

In the present embodiment, a person who does not carry an authentication card 31 although he/she is shot by the monitoring camera 221 is identified as a suspicious person or an intruder.

In the present embodiment, the authentication card 31 is an example of an RFID authentication card used as an RFID tag to be authenticated by the RFID reader 202, however, it may use any authentication means. Moreover, although the authentication card 31 is in the form of a card for the sake of description, it is not necessary to be in the form of a card.

The fire door/fire shutter 228 is a kind of fire preventive equipment prescribed in the Building Standards Act. The fire door is also called a fire shutter when it has a shutter form. The fire shutter is installed in each section not larger than 3,000 m² in a building facility. The fire door/fire shutter 228 is designed to normally allow people to pass throughbut prevent penetration of fire in case of fire. Therefore, it plays a significant role in prevention of damage from fires.

The fire door/fire shutter 228 is connected to the control unit 110 of the monitoring device 100 (connected by serial transmission). As described below, the control unit 110 detects an open/closed state of the fire door/shutter 229 (particularly, a not closed state of the fire door).

The smoke detector 234 is installed at each point in the facility and detects smoke from a fire. The smoke detector 234 may be an ionization smoke detector that detects a change in the state of ionization of air due to smoke from a fire, or a photoelectric smoke detector that detects diffuse reflection of light or light interception due to smoke from a fire. Alternatively, the smoke detector may be a smoke detector that extracts a number of characteristic amounts such as luminance, color, shape, and motion, etc., of smoke and performs image processing. A plurality of smoke detectors 234 are installed along a main passageway, etc. Each smoke detector 234 is connected (connected by serial transmission) to the control unit 110 of the monitoring device 100. As described below, the control unit 110 stores installation locations of the smoke detectors 234 together with layout information. The control unit 110 can detect a flow direction, volume and speed of smoke based on installation location information of each smoke detector 234 and smoke information (whether smoke has been detected and smoke volume) from each smoke detector 234.

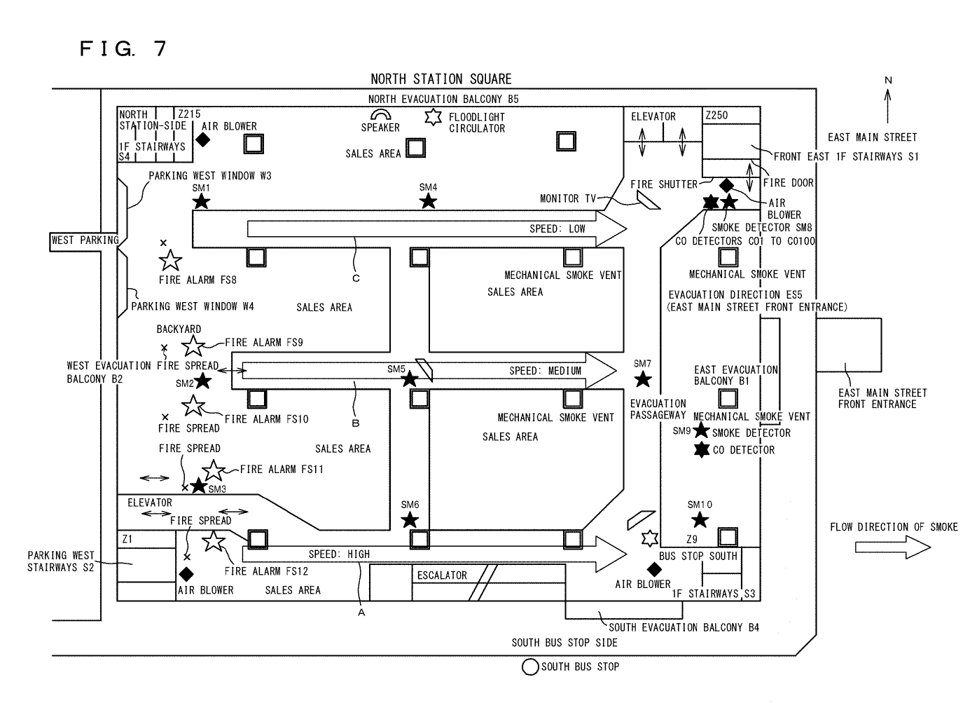

The air blower 235 may be a movable air blower (refer to FIG. 7 described below) which is installed at a smoke diffusion spot including openings such as windows or smoke vents around the exterior, and whose air blowing direction is changeable (refer to FIG. 7) or fixed, and forcibly blows smoke from a fire from smoke vents in a direction to maximally make the smoke harmless to people. For example, an air blower 235 installed near an emergency exit blows smoke generated from a fire outdoors. Accordingly, smoke generated from a fire is diffused. When the air blower 235 is a movable air blower, an air blowing direction may be set according to a flow direction, volume and speed of smoke based on smoke information detected by the smoke detectors 234.

[Portable Device 300]

The portable devices 300 are respectively carried by the plurality of relevant persons. The portable device 300 is, for example, a smartphone, a tablet computer, ora notebook. Besides, the portable device 300 is a PHS (Personal Handy-Phone System), a PDA (Personal Digital Assistants), or a dedicated terminal. In the present embodiment, the portable device 300 can be used by each relevant person at various locations (that is, at a current position), and can receive an e-mail or a video including a moving image from the monitoring device 100 through a phone line (not shown).

In the present embodiment, as the portable device 300, a smartphone or a tablet computer is assumed to be used, and can be used by each individual at various locations (that is, at a current position). One of the portable devices 300 is disposed at the headquarters/head office (not shown).

The portable device 300 comprises a Wi-Fi individual identifying device (hereinafter referred to as Wi-Fi master device) 301, an iBeacon master device 302, and a GPS (Global Positioning System) 303.

The Wi-Fi master device 301 receives and individually identifies radio waves of the Wi-Fi slave devices 201 installed in the work facility.

The iBeacon master device 302 stands by in the background in response to execution of an application with an iBeacon function. The iBeacon master device 302 transmits unique ID information when it comes close to the iBeacon slave device 203 installed in the facility, and an application associated with the ID information responds and the iBeacon master device obtains its own position information. Here, the monitoring device 100 accumulates disposition information of the iBeacon slave devices 203 installed in the facility in the safety-related information storage DB 135. Therefore, when the iBeacon master device 302 comes close to the iBeacon slave device 203, ID and a position of a relevant person who carries the portable device 300 with him/her can be determined.

The relevant person carries an RFID tag (authentication card 31) to be authenticated by the RFID reader 202 with him/her. According to authentication of the RFID tag (authentication card 31) that the relevant person carries, the RFID reader 202 captures a position of the relevant person who carries the authentication card 31 with him/her. Here, when the authentication card 31 is a passive tag, a communication receivable distance is 3 to 7 meters. By using an active tag with a built-in battery, specifications that realize a communication receivable distance of about 400 meters are possible.

In addition, the relevant person has a pressurized safety system 310 that determines an abnormality by detecting an abdominal pressure of a person who wears the system. The pressurized safety system 310 includes an abdominal pressure sensor (not shown), etc., that detects expansion and contraction of an abdominal area of a user and outputs an expansion/contraction signal (abdominal signal), etc., and transmits an emergency signal when a user applies an abdominal pressure. An abdominal signal obtained by the abdominal pressure sensor is transmitted to the portable device 300 by a wireless communication system using Bluetooth (registered trademark).

The GPS 303 receives a radio wave of position information from a GPS satellite, etc. From information received via a GPS antenna, the GPS 303 calculates current position information as three parameters of a latitude, a longitude, and an altitude to acquire position information. The acquired position information is transmitted to the monitoring device 100 on a timely basis.

In the present embodiment, an example using a GPS satellite as a means to acquire position information is shown, however, other than the GPS, a system using a positional relationship with a base station may also be used. For example, when an Android (registered trademark) smartphone or a sophisticated cell phone with a camera is used as the portable device 300 as a mobile terminal, it is also possible that, via abase station and a cell phone communication network (not shown) in place of or in combination with the GPS 303, information is transmitted to and received from a cell phone company's server, and current position information of the terminal itself is acquired upon an approach check.

Hereinafter, operation of the digital smart safety system 1000 configured as described above is described.

First, a basic concept of the digital smart safety system is described.

(1) A disaster such as a fire, smoke, or gas may occur in a building facility.

When a disaster occurs, this digital smart security safety systemproperlyguides evacuationof relevant persons, and ensures relevant persons' safety in the building facility.

(2) Accidents and incidents include intrusion of a suspicious person from the outside. Accidents and incidents also include information leakage from the inside of a company by an in-company relevant person.

This digital smart safety system guides all people to a safe place in case of fire, and in case of a suspicious person or intruder, notifies the current status to relevant persons in real time and prevents accidents and incidents.

[Fire Guidance Control]

In case of fire, all of the people in a facility are relevant persons. Accuracy and quickness of guidance information are preferentially required. As described above, many fatal accidents occur due to breathing difficulties caused by inhalation of smoke, so that a guidance to evacuate people from smoke is extremely important.

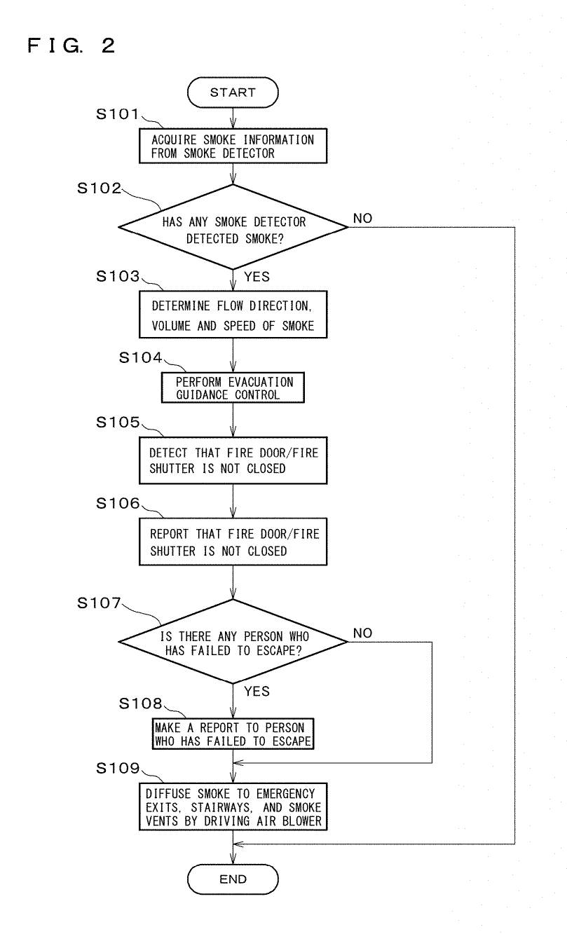

FIG. 2 is a flowchart showing fire guidance control of the control unit 110 of the monitoring device 100 of the digital smart safety system. This flow is repeatedly executed at predetermined timings (in units of ms) by the CPU constituting the control unit 110 (refer to FIG. 1). In consideration of urgency and importance of the fire guidance control, the fire guidance control is performed in priority to suspicious person/intruder determination control described below.

First, in Step S101, the control unit 110 acquires smoke information (whether smoke has been detected and smoke volume) from the plurality of smoke detectors 234 installed at various points in the facility.

In Step S102, the smoke determination means 112 (refer to FIG. 1) of the control unit 110 determines whether any one of the smoke detectors 234 has detected smoke. When no smoke is detected (Step S102: No), processing of this flow is ended. Many smoke detectors 234 are installed in the facility, and are set not to detect abnormality in the level of smoke (for example, smoke of a cigarette) other than smoke from a fire, so that processing of this flow is normally ended here.

When anyone of the smoke detectors 234 detects smoke (Step S102: Yes), in Step S103, the smoke determination means 112 of the control unit 110 determines a flow direction, volume and speed of the smoke based on facility layout information and the smoke information detected by the smoke detectors 234. In the safety-related information storage DB 135 shown in FIG. 1, installation locations of the smoke detectors 234 are stored together with the facility layout information. The control unit 110 can detect a flow direction, volume and speed of the smoke based on the installation location information of each smoke detector 234 and smoke information (whether smoke has been detected and smoke volume) from each smoke detector 234.

For example, when a certain smoke detector 234 detects smoke, the smoke determination means 112 determines smoke information of another smoke detector 234 near the smoke detector 234 that has detected smoke. By comparing smoke volumes detected by the respective smoke detectors 234, (1) a flow direction of the smoke (a direction from the smoke detector 234 that has detected a large volume of smoke to the smoke detector 234 that has detected a small volume of smoke) can be determined. Smoke spreads in all directions, however, depending on the status of a fire, the facility layout, air conditioning, and natural wind, etc., the smoke flow direction may differ. In the present embodiment, a direction of a stronger smoke flow and a direction of a comparatively weak smoke flow can be determined, so that high-quality evacuation guidance by which people are guided in a direction with a weak smoke flow can be realized.

(2) The smoke determination means 112 determines the severity of a fire, that is, a degree of urgency of evacuation from smoke volumes detected by the smoke detectors 234 (when there are many smoke detectors 234 that have detected a large volume of smoke, a degree of urgency is high). In the present embodiment, a degree of urgency of evacuation can be determined based on smoke volumes, so that evacuation guidance according to the degree of urgency can be realized. (3) A speed of smoke is determined by comparing temporal changes in smoke volume of the respective smoke detectors 234. In addition to factors similar to the directions of smoke flows described above, the speeds of smoke flows differ depending on fire preventive measures (use of fire retardants). In the present embodiment, a direction in which the flow speed of smoke is higher and a direction in which the flow speed of smoke is comparatively low can be determined, so that a high-quality evacuation guidance in that people are guided in a direction in which the flow speed of smoke is low, that is, a direction of weak fire can be realized.

Results of the determinations (1) to (3) described above are comprehensively judged by the control unit 110 , and an accurate evacuation guidance is realized.

Referring to the flow shown in FIG. 2 again, in Step S104, the control means 115 performs evacuation guidance control to designate a safe place based on the results of determination by the smoke determination means 112 and guide evacuation of facility relevant persons.

In Step S105, the fire door detection means 113 (refer to FIG. 1) of the control unit 110 detects whether a fire door/fire shutter 228 installed in the facility is not closed.

In Step S106, based on the results of detection by the fire door detection means 113, the control unit 115 reports that a corresponding fire door/fire shutter 228 in an evacuation route is not closed to the facility relevant persons. This report may be made by any one of announcement, video, Wi-Fi/RFID of the relevant persons, etc. By receiving this report, the relevant persons can close the not closed fire door/fire shutter 228 after confirming the safety, so that a situationwhere the fire door/fire shutter 228 that should be closed is left not closed can be avoided. In addition, even in a case where danger is imminent and the fire door/fire shutter cannot be closed, the not closed state of the fire door/fire shutter 228 can be known in advance and then evacuation can be made safely.

In Step S107, the human detection means 114 (refer to FIG. 1) of the control unit 110 determines whether there is a person who has failed to escape in case of fire. To detect a customer or relevant person who has failed to escape, the monitoring device 100 collects signals of the respective sensors (RFIDs, Wi-Fi, etc.). That is, the monitoring device 100 does not determine a suspicious person but detects a person who has failed to escape by using the respective sensors. For example, a person who is a customer or other person and has not registered his/her RFID reader 202 or portable device 300 and has failed to escape is detected.

When there is a person who has failed to escape (Step S107: Yes), in Step S108, the control means 115 (refer to FIG. 1) of the control unit 110 makes a report to the person who has failed to escape based on the results of detection by the human detection means 114. The report to the person who has failed to escape is made by transmitting an e-mail, a layout, an image, or sound to the portable device 300 of a relevant person near the personwho has failed to escape. The relevant person can respond to the report and rescue and evacuate the person who has failed to escape. When the speaker 223, etc., is present near the person who has failed to escape, the person who has failed to escape can be directly notified, and these methods may be used in combination. Accordingly, a communication channel to give an evacuation guidance to a person who has failed to escape increases , so that the effect of the evacuation guidance can be improved.

When there is no person who has failed to escape (Step S107: No), the process skips to Step S109.

In Step S109, when detecting smoke from a fire or at the time of an evacuation guidance, the control means 115 drives the air blower 235 to diffuse smoke to openings such as windows and smoke vents around the exterior. By diffusing smoke, inhalation of smoke at the time of evacuation can be reduced.

[Registration Processing]

Next, registration processing of various information of the digital smart safety system is described. In order to determine a suspicious person or intruder, the following registration processing must be performed in advance.

### (Face Authentication Registration)

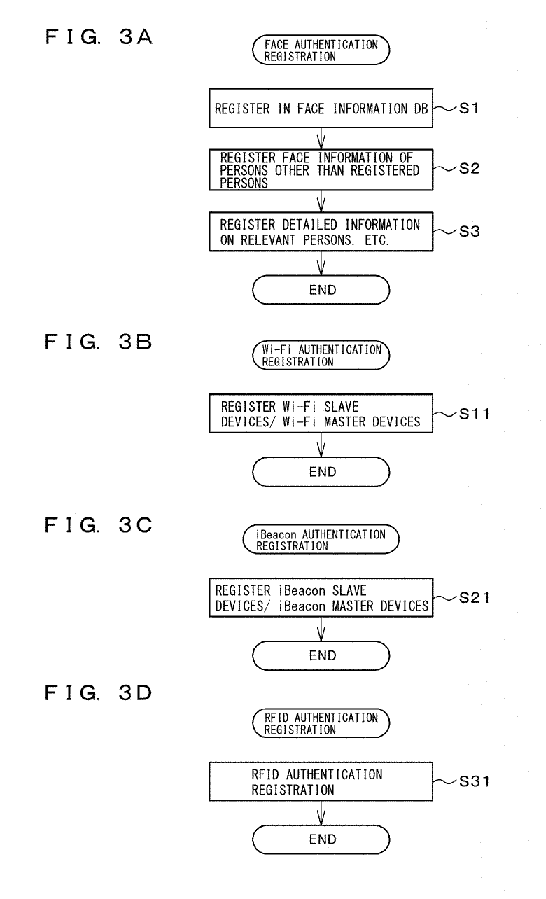

FIG. 3A is a flowchart showing person registration processing of the control unit 110 of the monitoring device 100 of the digital smart safety system. This flow is executed by the control unit 110 of the monitoring device 100.

In Step S1, the control unit 110 registers face information of persons issued with RFID authentication cards, facility relevant persons, and relevant persons, etc., in the face information DB 160. In detail, the control unit 110 acquires, from face regions, information representing humans' facial characteristics (face information) to be used for face authentication, and registers the information in the face information DB 160 in association with the individual images. In addition, the control unit 110 receives persons' images transmitted from the headquarters (not shown) and registers the images in the face information DB 160.

In Step S2, the control unit 110 registers, in the face information DB 160, face information of persons other than persons who carry registered RFID tags (authentication cards 31) to be authenticated by the RFID readers 202. Persons other than the persons who carry the registered authentication cards 31 are suspicious persons or suspicious vehicle drivers. These suspicious persons also include persons who habitually perform suspicious behavior. The person who habitually performs suspicious behavior is, for example, a person who frequently appears at a site of theft or a person reported in advance as a person on a blacklist from headquarters /head office ora security company. In the present embodiment, a level of monitoring a person who habitually performs suspicious behavior is set to be higher. Registration of face information of persons may be updating of the face information DB 160 from headquarters/head office or a security company.

In Step S3, the control unit 110 registers detailed information, vehicle registration numbers, and related information of persons issued with authentication cards 31, facility relevant persons, and relevant persons, etc.

(Wi-Fi Authentication Registration)

FIG. 3B is a flowchart showing Wi-Fi authentication registration processing of the control unit 110 of the monitoring device 100 of the digital smart safety system. This flow is executed by the control unit 110 of the monitoring device 100.

In Step S11, the control unit 110 connects the Wi-Fi slave devices 201 installed in the work facility and the Wi-Fi master devices 301, and registers these for Wi-Fi authentication. Positions at which the Wi-Fi slave devices 201 are installed are registered in the Wi-Fi master device 301.

When a relevant person passes through a radio region of the Wi-Fi slave device 201, the Wi-Fi master device 301 of the portable device 300 of the relevant person informs that the relevant person K3 is in the region of the Wi-Fi slave device 201 by transmitting a radio wave. The monitoring device 100 determines whether to authorize the relevant person by Wi-Fi authentication described below.

(iBeacon Authentication Registration)

FIG. 3C is a flowchart showing iBeacon registration processing of the control unit 110 of the monitoring device 100 of the digital smart safety system. This flow is executed by the control unit 110 of the monitoring device 100.

In the monitoring device 100, portable devices 300 of relevant persons are registered, and as an application of the portable devices 300, iBeacon slave devices with a radio wave identification range of approximately 10 cm to 5 m are provided.

In Step S21, the control unit 110 connects the iBeacon slave devices 203 installed in the work facility and the iBeacon master devices 302, and authenticates and registers the iBeacons.

(RFID Authentication Registration)

FIG. 3D is a flowchart showing RFID authentication registration processing of the control unit 110 of the monitoring device 100 of the digital smart safety system. This flow is executed by the control unit 110 of the monitoring device 100.

In Step S31, the control unit 110 connects RFID readers 202 installed inthework facilityandRFID tags, and authenticates and registers RFIDs.

[Monitoring Control of Monitoring Device 100]

### (Evacuation Guidance Control)

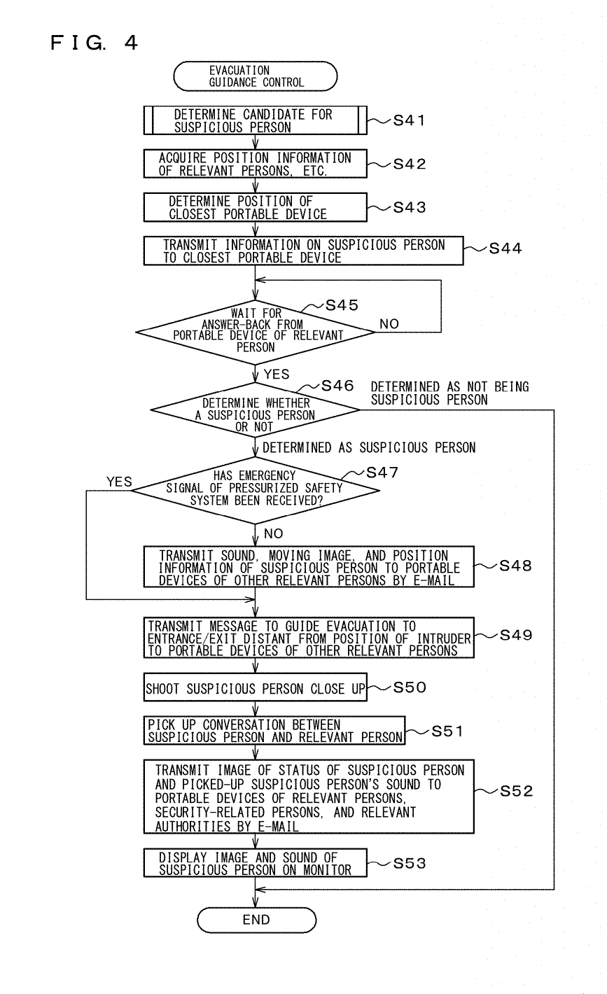

FIG. 4 is a flowchart showing evacuation guidance control processing of the monitoring device 100 of the digital smart safety system. This flow is executed mainly by the control unit 110 of the monitoring device 100.

First, in Step S41, the control unit 110 determines a candidate for a suspicious person/intruder (hereinafter referred to as suspicious person).

When a suspicious person is determined in Step S41 described above, in Step S42, the control unit 110 acquires position information of relevant persons close to the suspicious person.

In Step S43, the control unit 110 determines a position of a portable device 300 of a relevant person closest to the suspicious person based on the acquired position information.

In Step S44, the control unit 110 transmits information on the suspicious person preferentially to the relevant person closest to the position of the suspicious person. For example, the control unit 110 transmits sound, a moving image, and suspicious person position information (information of a facility layout with a mark thereon) by e-mail.

In this case, when the suspicious person distances himself/herself by a predetermined distance from the position of the closest portable device 300, information on the suspicious person may be transmitted to another portable device 300.

In Step S45, the control unit 110 waits for an answer-back from the portable device 300 of the relevant person to which transmission was performed. This relevant person says, for example, “Is there something wrong?” to a suspicious person or a candidate for arsonist (the same applies hereinafter), and when the relevant person recognizes the person as a suspicious person, he/she performs a predetermined button operation (touching a check key, etc.) on the portable device 300. Accordingly, an answer-back is returned to the monitoring device 100.

When an affirmative acknowledgement ACK is not returned from this portable device 300 in question even after an elapse of a predetermined time (for example, 5 seconds), or a negative acknowledgement NCK is returned from the portable device 300 in question, in Step S45, the control unit 110 determines a position of a portable device 300 next closest to the suspicious person the collation result with whom is a match, and transmits, to this portable device 300, information on the suspicious person.

In Step S46, the control unit 110 determines whether a suspicious person or not based on the result of answer-back from the portable device 300 in question. When a suspicious person is not determined, this flow is ended.

When a suspicious person is determined, in Step S47, the control unit 110 judges whether an emergency signal has been received from the pressurized safety system 310 of the portable device 300 in question.

When receiving no emergency signal from the pressurized safety system 310, the control unit 110 judges that the current situation is not a time when a life-threatening emergency has occurred, and in Step S48, the control unit 110 transmits sound, a moving image, and position information (information of a layout with marking thereon, etc.) to the portable devices 300 of other relevant persons by e-mail. Accordingly, other relevant persons can respond to the site of the suspicious person.

When receiving an emergency signal from the pressurized safety system 310, the control unit 110 judges that the current situation is a time when an emergency has occurred, and in Step S49, the control unit 110 transmits a message to guide evacuation to an entrance/exit distant from the position of the suspicious person (for example, layout information showing a moving route to the entrance/exit and a situation) to the monitors 222, the speakers 223, and the portable devices 300 of other relevant persons. Accordingly, by referring to this message, other relevant persons can guide evacuation of people (for example, store visitors) from the site of the suspicious person to the entrance/exit distant from the position of the suspicious person.

In Step S50, the control unit 110 causes the monitoring camera 221 that shoots the site of the suspicious person to pan, tilt, and zoom to shoot a close-up image of the suspicious person.

In Step S51, the control unit 110 picks-up a conversation between the suspicious person and a relevant person from the microphone 224 installed near the site of the suspicious person.

In Step S52, the control unit 110 transmits the taken-in image showing the status of the suspicious person (including a moving image) and the picked-up suspicious person's sound to the portable devices 300 of the relevant persons, security-related persons, and relevant authorities by e-mail. Other relevant persons can confirm the status of the suspicious person in real time, and prepare for responding to the site and accompanying caution. In addition, the status of the suspicious person can be accurately reported to the relevant authorities.

In Step S53, the control unit 110 displays an image and sound of the suspicious person on the monitors 222 and ends this flow. The image and sound of the suspicious person may be displayed on only the monitor 222 at the site of the incident (for example, on a corresponding floor).

The Steps S50 to S53 described above are not essential, and maybe skipped. As described below, these steps maybe added as appropriate according to an elapse of time or occurrence of an event after an emergency occurs.

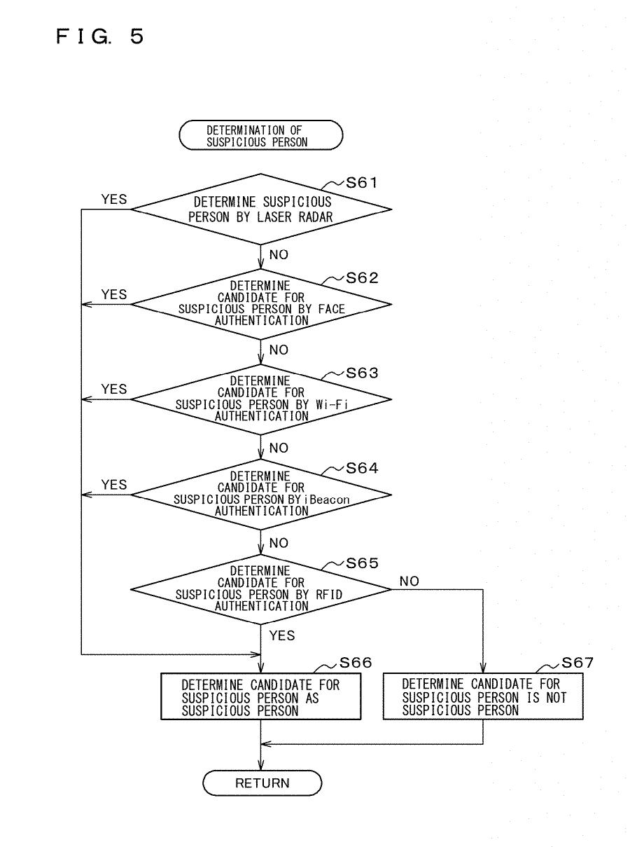

FIG. 5 shows a subroutine showing suspicious person determination processing of the monitoring device 100 of the digital smart safety system. This subroutine is a detailed flow of Step S41 shown in FIG. 4.

In Step S61, the control unit 110 determines a suspicious person by using the laser radar 212. In an important security section such as an office , a design room, a research and development room, a management room, etc., the laser radar 212 that detects a suspicious person is installed. The laser radar 212 is also installed at an entrance/exit, etc., in a building that people do not usuallyenteror exit from. When the laser radar 212 operates , an intruder (suspicious person) is determined (definitely determined) without waiting for the following processing.

When the laser radar 212 does not operate, in Step S62, the control unit 110 determines a candidate for a suspicious person by face authentication. In detail, the control unit 110 takes-in a video of the monitoring camera 221. It is determined whether a facial image of a person shot by the monitoring camera 221 matches a facial image of a relevant person such as a facility relevant person, a person with a registered RFID authentication card, a relevant person, etc. , and if the result of determination is not a match, this person is determined as a candidate for a suspicious person, and the process advances to Step S66.

When the person is not a candidate for a suspicious person, in Step S63, the control unit 110 determines a candidate for a suspicious person by Wi-Fi authentication. In detail, in the following description, the Wi-Fi master device 301 that receives and individually identifies radio waves of the Wi-Fi slave devices 201 is registered for Wi-Fi authentication. In addition, the positions of the installed Wi-Fi slave devices 201 are also registered in the Wi-Fi master device 301. When a relevant person passes through a radio region of the Wi-Fi slave device 201, it receives a radio wave of the portable device of the relevant person and transmits a radio wave showing that the relevant person K3 is in the region of the Wi-Fi slave device 201 to the Wi-Fi master device. The control unit 110 receives this radio wave and determines whether this relevant person is an authorized person by collation. When this person is a candidate for a suspicious person, the process advances to Step S66.

When the person is determined as not being a candidate for a suspicious person through Wi-Fi authentication, in Step S64, the control unit 110 determines a candidate for a suspicious person by iBeacon authentication. In detail, in the work facility, iBeacons with a radio wave identification range of approximately 10 cm to 5 m are installed. In addition, in the monitoring device 100, portable devices of the relevant persons in the work facility are registered. When a relevant person passes through or performs work at a location where the iBeacon is positioned, the portable device of the relevant person receives a radio wave transmitted from the iBeacon. The portable device of the relevant person transmits a radio wave showing it is present at the position of the iBeacon to the monitoring device 100. The control unit 110 receives this radio wave and determines whether this relevant person is an authorized person by collation. When the person is a candidate for a suspicious person, the process advances to Step S66.

When the relevant person is determined as not being a candidate for a suspicious person through iBeacon authentication, in Step S65, the control unit 110 determines a candidate for a suspicious person by RIFD authentication. In detail, RFID readers 202 are installed in the work facility. RFID tags (authentication cards 31) are lent to relevant persons who enter and exit from the work facility and clients authorized to perform work. The lent RFID tag (authentication card 31) is permitted to enter and exit from facilities such as passageways, areas, storehouses, and work rooms in a permitted time (day). When the relevant person or client makes entry or exit or performs work within a radio-wave transmission distance of the RFID reader 202, the RFID tag of the portable device 300 of the relevant person or client receives a radio wave transmitted from the RFID reader 202. The control unit 110 receives a radio wave of this RFID tag, and determines whether the relevant person or client is an authorized relevant person or client by collation, and determines his/her position. When the person is a candidate fora suspicious person, the process advances to Step S66.

When the person is determined as a suspicious person through the RIFD authentication, the candidate fora suspicious person determined in Step S66 is identified as a suspicious person and the process returns to Step S41 shown in FIG. 4.

When the person is determined as not being a suspicious person through the RIFD authentication, the candidate for a suspicious person determined in Step S67 is identified as not being a suspicious person and the process returns to Step S41 shown in FIG. 4.

The order of executing Steps S61 to S66 may not be the processing order described above. In addition, only a part of authentications of Steps S61 to S66 described above maybe used.

(Mode-Response Control)

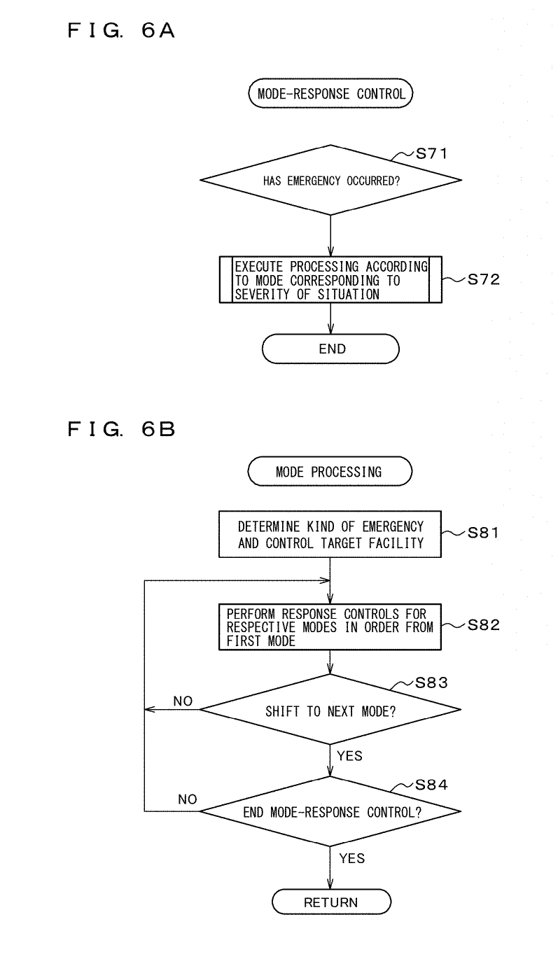

FIG. 6A is a flowchart showing mode-response control processing of the monitoring device 100 of the digital smart safety system. This flow is executed mainly by the control unit 110 of the monitoring device 100.

First, in Step S71, the control unit 110 determines whether an emergency has occurred. When no emergency occurs, this flow is ended. The emergency is assumed to be a fire or an accident or incident caused by intrusion of a suspicious person. In case of fire, a fire alarm operates and a signal is output from a faint current sensor attached to a fire door, etc., to detect smoke. In case of an accident or incident caused by intrusion of a suspicious person, a report is made from the portable device 300 of a relevant person near the suspicious person. On the monitoring device 100 side, results of monitoring by the monitoring camera 221, etc., are also included.

In case of an emergency, in Step S72, the control unit 110 shifts to an n-th mode (n is an integer not smaller than 2), and executes processing according to a mode corresponding to severity of the situation. The mode number of the n-th mode and the time of shifting from a mode to a next mode can be set according to importance. Shifting from a mode to a next mode may be triggered not by time but by an event.

For example, in a first mode, information on a suspicious person is transmitted by e-mail to the portable device 300 of the relevant person, and when the suspicious person does not leave afters seconds, the mode shifts to a second mode, and the monitoring camera 221 is set in a direction toward a position in question where the suspicious person is, and shoots the intruder. Then, when the intruder does not leave even after 10 seconds, the mode shifts to a third mode, a power supply of a PC, etc., is cut off to prevent information of the work facility from being stolen, and other relevant persons are made to respond to the site. Further, when the intruder does not leave even after another 10 seconds, the mode shifts to a fourth mode, and after issuing a warning by sound, a report to and collaboration with relevant authorities are made.

In this way, according to the first to fourth modes corresponding to severity of the situation, the level of security specifications can be raised in a phased manner, and security appropriate for the situation can be realized. That is, the security level is made different by mode corresponding to severity of the situation, so that it can be avoided that excessive security is made and ends up worsening the situation and wastes time, while there is no possibility that the security is insufficient and is not effective.

In the present embodiment, the control unit 110 of the monitoring device 100 performs the evacuation guidance control (refer to FIG. 4 and FIG. 5) and the mode-response control (refer to FIG. 6) in parallel. The evacuation guidance control may be incorporated into the mode-response control. In any control, it is preferable to prioritize the evacuation guidance control.

(Mode Processing)

FIG. 6B is a flowchart showing mode processing of the monitoring device 100 of the digital smart safety system. This subroutine is a detailed flow of Step S72 shown in FIG. 6A.

In Step S81, the control unit 110 of the monitoring device 100 determines the kind of the emergency and a control target.

In Step S82, the control unit 110 performs response controls for the respective modes in order from the first mode according to the kind of the emergency and a control target facility.

In Step S83, the control unit 110 determines whether or not to shift the next mode according to an elapse of time or occurrence of an event. When the mode does not shift to the next mode, the process returns to Step S82.

When the mode shifts to the next mode, in Step S84, whether or not to end the mode-response control is determined. When the mode-response control is not ended, the process returns to Step S82. When the mode-response control is ended, the process returns to Step S72 shown in FIG. 6A.

Hereinafter, application examples of the digital smart safety system 1000 are described.

A method of operating the digital smart safety system 1000 in case of fire is described.

### APPLICATION EXAMPLE 1

A resident population for economic activities or residency, etc., in a commercial facility, a hotel, a multistoried office, a multipurpose complex building, a meeting place, a hospital, a theater, a college, a factory, a multi storied or super high-rise apartment building, a terminal building, an underground mall, a ship, individually owned housing, etc., is large, and in case of fire, when and an unspecified number of people are there, a panic caused by smoke, flame, and gas is significantly impacted.

The digital smart safety system 1000 provides a system that grasps a fire in real time, and safely evacuates an unspecified number of people residing in a building facility without accidents. The systemenables relevant persons to accurately guide evacuation, and residents to evacuate to a stairway, evacuation facility, and entrance/exit in order of nearness in a direction opposite a fire site based on the status of the fire.

First, an evacuation guidance of the digital smart safety system 1000 in case of fire is described.

FIG. 7 is a view showing an upper-floor layout of a commercial facility in case of fire.

As shown in FIG. 7, this upper floor of the commercial facility includes stairways, special evacuation stairways, evacuation facilities, emergency elevators, etc., sales areas, passageways, various corners, an accommodation room, an office, and a dwelling, etc., and comprises smoke detectors, flame detectors, heat detectors (hereinafter referred to as fire alarms), CO detectors 233, RFID readers 202, monitoring cameras 221, monitors 222, motion sensors 211, Doppler sensors (not shown), laser radars 212, speakers 223, smoke detectors 234 (smoke detection means) (refer to filled stars), and direction movable air blowers 235 (refer to filled diamonds).

A fire occurs around the backyard on the west side of the commercial facility shown in FIG. 7, and as shown by the cross marks in FIG. 7, the fire spreads. The monitoring device 100 acquires smoke information (whether smoke has been detected and smoke volume) from each of the smoke detectors SM1 to SM10 (refer to filled stars) to detect “a direction, volume and speed” of the smoke, and designates a safe place and gives a guidance to there.

<Detailed Example 1 of Flow Direction and Speed of Smoke>

In this situation, all of the smoke detectors SM1 to SM10 on this floor of the facility detect smoke. It is detected that the smoke volume increases in the order of the smoke detectors SM3, SM2, SM1, SM6, SM5, SM4, shown by the outlined arrow in FIG. 7, the smoke can be determined to generally flow in a direction from the west to the east of the commercial facility. Focusing on the smoke volumes detected by the smoke detectors SM6, SM5, and SM4, a part of the smoke can be determined to flow from the south to the north as well. Further, it is assumed that the flow speed of the smoke is determined to be higher in a direction from the smoke detector SM3 to the west (“smoke flow direction” A) than in a direction from the smoke detector SM2, SM1 to the west (“smoke flow direction” B, C). From these results of determination, first, the monitoring device 100 determines directions of general smoke flows, that is, the “smoke flow direction” A, the “smoke flow direction” B, and the “smoke flow direction” C. Next, among the “smoke flow directions” A, B, and C, by comparing the speeds of the smoke flows, the monitoring device determines a final evacuation guiding direction. Here, the smoke speed is highest in the “smoke flow direction” A, and becomes lower in order of the “smoke flow directions” B and C. The smoke speed is lowest in the “smoke flow direction” C, so that an impact from the smoke is least in the “smoke flow direction” C. Therefore, a safe evacuation guiding place in this facility is determined to the “front east side” at the northeast corner of the commercial facility shown in FIG. 7, and evacuation is guided to this “front east side” where impact from the smoke is the least.

In the present embodiment, not only smoke flow directions but also smoke speeds are used as a factor for determination, so that a detailed (safer) evacuation guidance as described above is enabled.

<Detailed Example 2 of Flow Direction and Speed of Smoke>

Here, when a smoke flow speed is very high, there is a possibility that a fire in this direction has rapidly spread. In this case, the monitoring device 100 guides evacuation to avoid the direction of the high smoke flow speed. This is described in detail below.

A case where the smoke speed has rapidly become high in the “smoke flow direction” A is assumed in FIG. 7. However, the smoke volume is comparable with that in the “smoke flow direction” B. In this case, the fire is determined to rapidly spread in the “smoke flow direction” A, and to ensure future safety, the evacuation guidance in the “smoke flow direction” A is switched to an evacuation guidance in the “smoke flow direction” B. In the present embodiment, the smoke speeds are also used as a factor for determination, and without determining smoke speeds, the “smoke flow directions” A and B cannot be distinguished from each other only based on the smoke directions and volumes. In the present embodiment, by using the smoke flow speeds in combination with smoke flow directions and volumes, a future evacuation guidance is enabled.

In the present embodiment, by determining smoke speeds, an improvement in control accuracy (detailed example 1) and a future evacuation guidance (detailed example 2) are enabled.

Next, a mode-response control evacuation guidance of the digital smart safety system 1000 in case of fire is described.

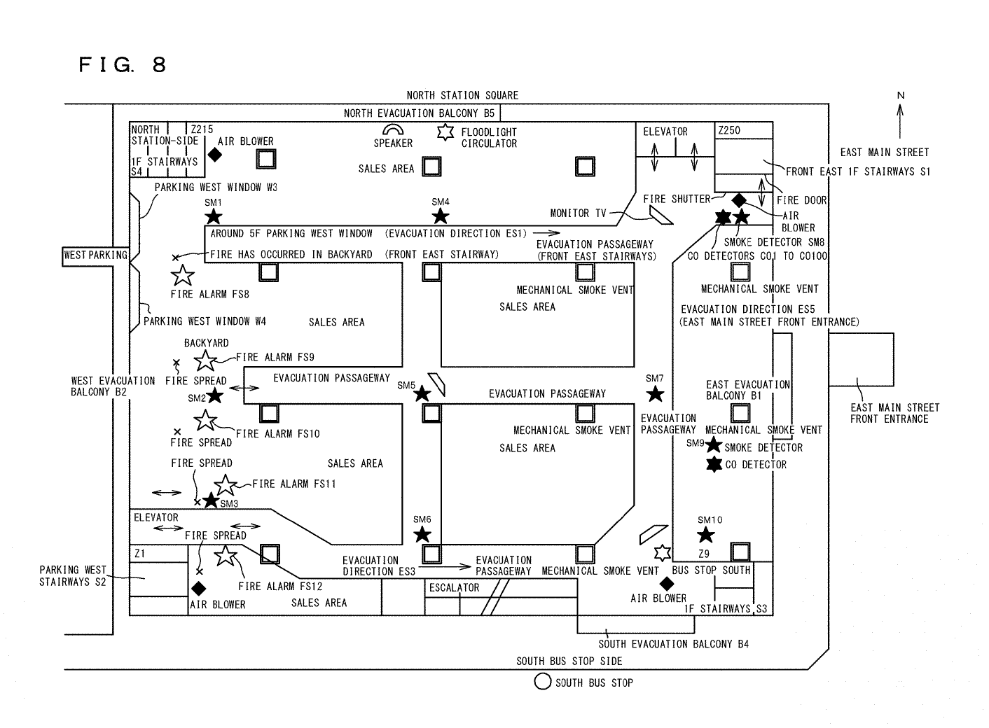

FIG. 8 is a view showing an upper-floor layout of a commercial facility in case of fire. For the sake of description, FIG. 7 is described again.

A LAN is constructed over the whole building facility and connected to the digital smart safety system 1000. The monitoring device 100 stores distances between a fire position and stairways, special evacuation stairways, evacuation facilities, and entrances/exits.

The monitoring device 100 identifies a fire position, and transmits, to portable devices 300 of relevant persons, each set of stairways, evacuation facility, and entrance/exit in order of nearness in a direction against the fire position. The relevant persons can properly guide store visitors and instruct relevant persons to rescue store visitors who have failed to escape.

The monitoring device 100 makes notification to store visitors, facility visitors, and relevant persons by using the monitors 222 and the speakers 223, and safely guides evacuation of people to each set of stairways, evacuation facility, and entrance/exit in order of nearness in a direction against the fire position.

When the facility is filled with flame, smoke, or gas, particularly when smoke that hinders vision and a toxic gas such as CO that has a harmful influence onhumanbodies are detected, the monitoring device 100 makes the direction movable air blower operate and blow air.

The concentrations of smoke and CO are reduced, and store visitors and relevant persons in the building facility can be quickly and safely guided for evacuation through an evacuation stairway, an evacuation facility, a special evacuation stairway, or an emergency elevator.

Because of business operations, in evacuation stairways, evacuation facilities, and fireproof compartments of a building facility, fire shutters and fire doors are opened to allow passage. When a fire alarm detects a fire, the fire shutters and fire doors automatically close. At the time of emergency evacuation incase of fire, a situation where an object is caught by the circumference of afire shutter, fire door or a floor surface, and even after the fire shutter or fire door closes, the evacuation stairways, evacuation facility, or fireproof compartment is filled with smoke, gas, and flame and people get involved in an accident has frequently occurred. A faint current sensor (not shown) attached to the fire shutter or fire door works, and when there is a gap, an electric current is not conducted.

The monitoring camera 221 interlocked with the monitoring device 100 takes an image of the fire, and the monitoring device 100 identifies a position of the fire. The monitoring device 100 transmits, to portable devices 300 of relevant persons, a layout chart showing the fire position and the image. The relevant persons can thus make a response in real time.

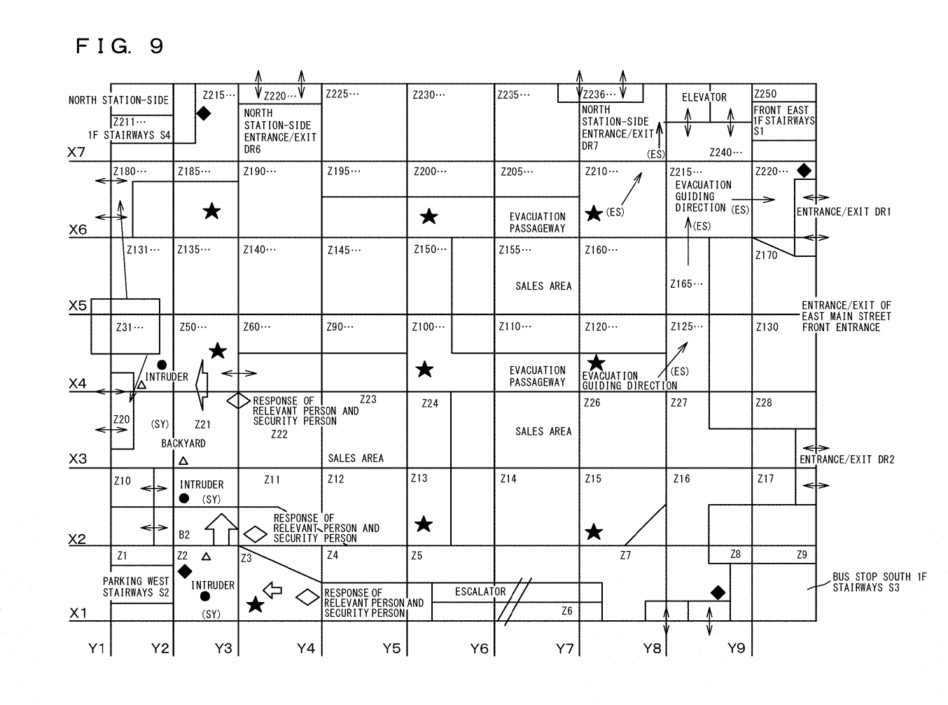

As shown in FIG. 7, an upper floor of the building facility includes sales areas, sales corners, a valuable item sales area, passageways, stairways, evacuation facilities, elevators, and entrances/exits, etc. According to the building shape and scale, the building facility is sectioned into blocks Z1B, Z2B, Z3B. .. , and Z250B by horizontal axes X1, X2, and X3 to X7 and vertical axes Y1, Y2, and Y3 to Y9 (FIG. 9). The monitoring device 100 stores, in the safety-related information storage DB 135, distances of evacuation stairways, special evacuation stairways, emergency elevators, evacuation facilities, and passageways, etc., in the building facility.

The building facility is designed so that anyone of store/facility visitors and relevant persons can understand the positional relationship. For example, among the east, west, south, and north sides of the building facility, a main street balcony B1 and a main street front stairways S1 are on the east side, a parking-side balcony B2, a stairways S2 leading to the parking, and parking-side windows W3 and W4 are on the west side, a bus-stop-side balcony B4 and a bus-stop-side stairways S3 are on the south side, and a station-side balcony B5 and a station-side stairways S4 are on the north side.

The monitoring device 100 stores an external opening layout of the building facility, and stores a floor-number-specific layout and names of the interior of the building facility. The monitoring device 100 stores, in the safety-related information storage DB 135, areas and positions of the evacuation stairways S1 to S4, the evacuation balconies B1 to B4, the emergency facilities E1 to E4, fire extinguishing equipment G1 to G4, and the fire alarms FS1 to FS80, etc., in the floor-number-specific layout by floor number, and stores, in the safety-related information storage DB 135, authentication numbers of the RFID readers 202 and the portable devices 300 of in-facility guides N1 to N20.

A case where a fire occurs in the block Z135 in the “area of the west windows W3 and W4 in the 5th-floor parking” is taken as an example. The fire alarm FS8 detects this fire. Themonitoringcamera 221 that detects the block Z135 as adetecting section shoots the direction of the fire in conjunction with the fire alarm. The monitoring device 100 inputs this information into the safety-related information storage DB 135. In the database of the monitoring device 100, distances of the east stairways S1, the south stairways S3, and the north stairways S4 (hereinafter, including evacuation balconies as well) that are highly safe and on the side distant from and opposite to the block Z135 are stored in advance.

In the configuration described above, the monitoring device 100 executes processing according to a mode corresponding to severity of the situation.

In a first mode (report), because of the nature of a fire, collation with a layout of the block Z135 in the “area of the west windows W3 and W4 on the 5th-floor parking” is performed as priority processing. The monitoring device 100 transmits the status of the fire in the area and position of the fire alarm F8 in the block Z135 and the layout showing the east stairways S1, the south stairways S3, the north stairways S4, and an entrance/exit that are distant from the block Z135 in which the fire has occurred and highly safe, to portable devices 300 of relevant persons. In detail, the monitoring device 100 transmits a two-split moving image showing the status of the fire, including a moving image A of a wide range and a close-up moving image B of the fire. In addition, the monitoring device 100 transmits picked-up sound in the status of the fire to the portable devices 300 of relevant persons by e-mail. The relevant persons confirm them in real time and can respond to the site and make a report to relevant authorities.

The relevant persons can report the occurrence of the emergency to security-related persons and relevant authorities, and many store visitors can safely evacuate without panic and accidents.

In the second mode (evacuation), after 5 seconds, a layout showing an evacuation route in a highly safe direction against and distant from the block Z135 in which the fire has occurred is transmitted to the portable devices 300 of the relevant persons by e-mail. As an evacuation direction, in a case where an order of priority for evacuation methods is determined in advance, stairways to which an evacuee can evacuate by himself/herself is given first priority. In this case, a layout clearly showing the east stairways S1, the south stairways S3, the north stairways S4, and the 1st-floor entrance/exit is transmitted. As described above, the two-split moving image of the status of the fire at the fire position in the block Z135 is displayed, includingthemoving imageAof the wide range showing an evacuation direction, and the close-up moving image B of the fire.

The monitoring device 100 broadcasts the emergency on the monitors 222 installed in the building facility. Store visitors and relevant persons staying in the building facility watch or listen to the in-store broadcast, and the status of the fire is clarified for evacuees. The evacuees can safely evacuate without falls, panic, or failure to escape, etc.

In broadcasting on the monitors 222, what status the fire is in and which direction the fire spreads and expands should be shown by displaying the moving image A of the wide range and the close-up moving image B of the fire. The status of the fire at the fire position in the block Z135 can be understood by watching the images.

Further, the monitoring device 100 makes a notification by sound from the speaker 223. An evacuee can evacuate in a highly safe evacuation direction, for example, from stairways to the east stairways S1 at the main street front entrance, the south stairways S3 on the south side of a bus stop, or the north stairways S4 on the station side while watching the accurate the status of the fire and listing to the sound.

After an announcement by the fire alarm, firefighting equipment for initial fire extinction such as sprinklers and an indoor fire hydrant operate to carryout firefighting. However, when the fire continuously spreads, the mode shifts to a third mode.

In the third mode (evacuation), after 10 seconds from detection of the fire by the fire alarm FS8, when the fire expands to the blocks Z50, Z10, and Z2 and the smoke detector (not shown) detects this and activates an alarm, the monitoring device 100 receives alarm signals of the fire alarms FS9 to FS12. The monitoring cameras 221 turn to and shoot the blocks Z50, Z10, and Z2 to which the fire spreads, and store the images in the safety-related information storage DB 135 of the monitoring device 100.

The monitoring device 100 transmits, to the portable devices 3 00 of the relevant persons, a layout of the south stairways S3, the north stairways S4, and the 1st-floor entrance/exit that are safe evacuation facilities on the opposite side of the fire. As described above, the two-split moving image, etc., showing the status of the fire in a range from the fire position in the block Z135 to the blocks Z50, Z10, and Z2, including the moving image A of the wide range and the close-up moving image B of the fire, are transmitted.

The monitoring device 100 performs emergency broadcasting on the monitors 222 installed in the building facility. Store visitors and relevant persons in the building facility can clearly know the status of the fire from in-facility broadcasting, and safely evacuate to an evacuation stairways without falls, panic, or failure to escape.

### APPLICATION EXAMPLE 2

### (Influence of CO)

Management personnel and relevant persons utilize the building facility for business work, and store visitors and facility visitors utilize the building facility as customers. In case of fire, management and relevant persons engage in evacuation guidance of customers. There are many cases where people evacuate in flocks at one time and crowd, and therefore, people cannot smoothly evacuate and fail to escape. The risk of fire increases due to fullness of flame, smoke, and toxic gases, etc., in proportion to the elapse of time after the occurrence of the fire.

In the case where a building facility is a super high-rise and expansive, an enclosed underground mall, an overseas passenger ship, etc., the population in the facility is large. The risk caused by the structural scale and complexity of the facility is incomparably higher than that of a low-rise and small facility. The responsibilities of management personnel and relevant persons in companies and corporations for safe and quick evacuation activities of customers have increased.

In some cases, a ghastly accident occurs in which, due to fulfilling the responsibilities as a company staff member, after evacuating customers and then evacuating general relevant persons, at last, management personnel fails to escape while checking if all people have evacuated safely.

In case of fire, an accident is caused by flame, smoke, and CO as a toxic gas. When an evacuee tries to safely evacuate, an accident occurs in which an evacuation stairways, evacuation balcony, or emergency elevator is filled with smoke and CO, etc., and vision is hindered, and the evacuee fails to escape due to CO poisoning, etc.

There are legally defined installation standards for smoke ventilation systems, and for example, mechanical smoke ventilation and natural smoke ventilation are evenly installed. The circulator 229 that can be used as both of a fixed type and a movable type is installed at evacuation stairways, evacuation balconies, the fronts of emergency elevators, and the evacuation passageways. The movable type air blower is interlocked with the fire alarm A or the fire alarm B, for example, the fire alarm A that has detected a fire, and the monitoring camera 221, the floodlights, and the air blower turn to the fire alarmA and perform shooting, light projection, and work.

Even if such smoke ventilation systems (mechanical smoke ventilation devices and natural smoke ventilation windows/openings, etc.) are installed, in some cases, the fire strongly spreads to the blocks Z140, Z60, Z10, and Z3 from the blocks Z135, Z50, Z10, and Z2 over the flame barriers. When the fire comes to a distance of approximately 20 m to a human at which it affects human activities, the smoke detector detects the fire. In this case, the smoke detectors SM1 to SM10 and CO detectors CO1 to CO100 detect the fire.

The monitoring device 100 stores positions of evacuation stairways, evacuation balconies, and emergency elevators to which evacuees staying in the building facility can safely evacuate, positions of smoke detectors, and distances between these in the database.

Here, the building facility is divided into the blocks Z1 to Z250. The air blower works toward a smoke vent of the smoke ventilation system to discharge smoke and CO outdoors. When the force of the fire is strong, the facility is filled with an irritating odor of smoke and CO, etc., and smoke and CO flow to evacuation stairways, evacuation balconies, and emergency elevators from other blocks, the monitoring device 100 detects signals of the smoke detectors SM1 to SM10 and CO detectors CO1 to CO100, and makes the air blowers in the blocks in question work. Accordingly, the smoke and CO are diffused toward the front peripheries of the evacuation stairways, evacuation balconies, and emergency elevators. Vision can be cleared, the irritating odor is removed, and safe evacuation of the evacuees can be supported.

In case of fire, the monitoring device 100 executes processing according to a mode corresponding to severity of the situation.

As described above, in the digital smart safety system 1000, the Wi-Fi slave devices 201, the RFID readers 202, iBeacon slave devices 203, and motion sensors 211 are installed in the building facility, RFID tags are lent to relevant persons, and the relevant persons are made to carry the portable devices 300 with them. In the work facility, the Wi-Fi slave devices 201, the RFID readers 202, the motion sensors 211, and the iBeacon slave devices 203 are always working at a higher security level. In the business facility, the motion sensors 211 are usually OFF since the motion sensor obstructs passage and shopping, etc., of customers.

In the first mode, a fire alarm detects a fire, and the monitoring device 100 gives a guidance as quickly as possible, for example, within 5 minutes by using the monitors 222 and the speakers 223. It is important to safely evacuate customers and other relevant persons outdoors. When most of the customers and relevant persons in the business facility can evacuate in 5 minutes after the occurrence, to prevent a panic or an accident, the motion sensors 211 that detect where humans are, are not made to work. Therefore, congestion of processing during evacuation guidance control can be prevented, and the processing can be concentrated on accurately guiding evacuation of customers.

In the second mode, after an elapse of 5 minutes from detection of the fire by the fire alarm, a customer or relevant person who has failed to escape is found. Most of the customers and relevant persons evacuate fromthe building facility, however, it is also assumed that some are involved in flame, smoke, toxic gases, etc., and fail to escape. In order to detect a customer or relevant person who has failed to escape, the monitoring device 100 collects signals of the respective sensors (RFIDs and Wi-Fi, etc.). That is, the monitoring device 100 does not determine a suspicious person but detects a person who has failed to escape by using the sensors. For example, people who are customers and other persons without registered RFID reader 202, portable device 300, and have failed to escape, are detected. For example, the Wi-Fi devices detect at which of the smoke detectors SM1 to SM10 in the blocks Z1 to Z250 of the building facility a person who has failed to escape is. In addition, the motion sensor 211 in the block Z30 detects that a person is at the motion sensor 211 in the block Z30. The monitoring device 100 transmits an e-mail, a layout, an image, and sound to the portable device 300 of a relevant person near Z30. The relevant person responds to the management personnel in Z30, and can rescue and evacuate the person who has failed to escape.

In the third mode, for a customer who has failed to escape, the digital smart safety system 1000 performs control. After the fire alarm detects a fire, when 10 to 15 minutes elapse, people residing in the business facility or work facility of the building facility are assumed to be management personnel, relevant persons, and customers who have failed to escape. In particular, relevant persons and management personnel rescue people who have failed to escape from the business facility in cooperation with relevant authorities. In case that the relevant persons, management personnel, and persons of relevant authorities cannot know an evacuation passageways, stairways, and entrances/exits due to fullness of flame, smoke, and toxic gases, the monitoring device 100 interlocks the monitoring cameras 221 with sensors in the blocks Z120 to Z125 in which people who have failed to escape are assumed to stay. Then, the monitoring device 100 transmits a layout of the blocks Z120 to Z125 to the portable devices 300 of the relevant persons outside. Accordingly, relevant persons and persons of relevant authorities, etc., fully-equipped with heat-resistant protective suits and oxygen masks resistant to flame, smoke, and toxic gases search in the blocks Z120 to Z125 in which the people who have failed to escape stay while considering secondary damage, and can securely and quickly guide evacuation and support rescue.

In the fourth mode, after an elapse of 15 minutes from detection of the fire by the fire alarm, people residing in the business facility and the work facility of the building facility are assumed to be management personnel, relevant persons, and customers who have failed to escape. The monitoring device 100 broadcasts features of disposition of the evacuation stairways, evacuation facilities, evacuation passageways, and entrances/exits, the presences of the same evacuation stairways, evacuation facilities, evacuation passageways, and entrances/exits by using the speakers 223 installed in front of the evacuation stairways, evacuation facilities, and entrances/exits. When vision is hindered by fullness of flame, smoke, and toxic gases and the relevant persons, management personnel, and persons of relevant authorities cannot know an evacuation passageway, stairway, and entrance/exit, a guidance may be given to people remaining in the building by sound. However, when the fire origin and the force of the fire are strong and the facility is filled with fire alarms and toxic gases, a guidance by broadcasting with the speaker is not given. This is to prevent evacuation according to the sound guidance in an imminent situation from adversely increasing the danger.

Next, a method of operating the digital smart safety system 1000 in case of an accident or incident in a work facility of a building facility is described.

### APPLICATION EXAMPLE 3

The digital smart safety system 1000 is used in a multipurpose commercial facility, office, complex facility, server facility, financial facility, factory, underground mall, station, air terminal, stadium, ship facility, etc. (hereinafter referred to as building facility). When such a building facility is used as a work facility, an unspecified number of people come to the facility or store, and a large number of persons relevant to a corresponding company enter and work in the facility.

FIG. 9 is a view showing a 1st-floor layout of a commercial facility as a work facility.

As shown in FIG. 9, this commercial facility includes entrances/exits to allowpeople to enter and exit from the facility, important sales areas, passageways, and corners, etc., and comprises a safety-related device 200 including a Wi-Fi slave device 201, an RFID reader 202, an iBeacon slave device 203, a monitoring camera 221, a monitor 222, a motion sensor 211, a laser radar 212, and a speaker 223, etc. A function range of the safety-related device 200 is defined as one block, and the facility is divided into, for example, 1 to 70 blocks.

In the safety-related information storage DB 135 of the monitoringdevice 100, distances between the respective blocks and evacuation facilities such as the 1st-floor entrances/exits, stairways on the basement and upper floors such as 2nd to 28th floors, etc., and emergency elevators (ELV). This is to enable facility/store visitors and relevant persons to directly evacuate.

The monitoring device 100 monitors whether there is an abnormality in the whole building facility including entrances/exits,gates,andsales areas, etc., in important areas of the building facility, and general areas and restricted areas. The monitoring device 100 monitors suspicious behavior persons, suspicious persons on a blacklist, mischievous behavior, accidents, and behavior leading to a crime, etc. The monitoring device 100 transmits e-mails, sound, and images to the portable devices 300, etc., of relevant persons. The relevant persons can make a response in real time. In addition, illicit and criminal behavior can be prevented and the security can be improved.

The monitoring device 100 preferably monitors the work facility for 24 hours includingoperatinghours and facility/store closed hours.

(1) Wi-Fi

Each of work relevant persons K1 to K150 (not shown) registers and carries a portable device 300. Positions of the installed Wi-Fi slave devices 1 to 200 (not shown) are registered in the Wi-Fi master devices 301.

When the relevant person K3 passes through or works in a radio region of the Wi-Fi slave device, the Wi-Fi slave device receives a radio wave of the portable device 300 of the relevant person K3, and transmits, to the Wi-Fi master device 301 of the portable device 300 of the relevant person K3 , a radio wave showing that the portable device 300 is in the region of the Wi-Fi slave device 201. The monitoring device 100 determines whether or not the person in this region is authorized.

(2) iBeacon

In the work facility, portable devices 300 of, for example, executive relevant persons of a company are registered in the safety-related information storage DB 135 of the monitoring device 100. In addition, in the work facility, iBeacon slave devices 203 with a radio wave identification range of 10 cm to 5 m are installed. Connection to a router of a LAN configuration can be made in any of a wired manner and a wireless manner. The router is connected to the monitoring device 100.

When the relevant person K8 passes through or works at a position of the iBeacon slave device 203, the iBeacon slave device 203 receives a radio wave transmitted from the iBeacon master device 302 of the portable device 300 of the relevant person K8. The portable device 300 of the relevant person K8 transmits a radio wave to the monitoring device 100 to inform that the portable device is at the position of the iBeacon slave device 203. The monitoring device 100 determines whether the relevant person K8 is authorized by referring to the safety-related information storage DB 135.

(3) RFID

In the work facility, RFID readers 202 are installed to ensure security within a radio transmission distance in a permitted time. The monitoring device 100 stores locations where the RFID readers 202 are installed, work areas, room names, days, and times, etc., in the safety-related information storage DB 135.

To a relevant person who is authorized to enter and exit from the work facility and work there, an RFID tag (authentication card 31) that can regularly access the RFID readers 202 is lent. By carrying the lent tags, relevant persons and clients of the company can enter and exit from permitted passageways, areas, storehouses, and work rooms, etc., and work.

A relevant person or client who carries an RFID tag with him/her is authorized to enter and exit from the facility and work there in a determined time zone on a determined day, however, when the relevant person or client performs a behavior other than permittedbehavior, the monitoring device 100 transmits an e-mail, sound, and an image to the portable device 300 of a relevant person. The relevant person can make a response in real time.

(4) When a Result of Authentication is a Mismatch

When the radio wave does not match the RFID reader 202 or the person does not carry an RFID tag, the monitoring device 100 extracts a floor number, an area, and a layout in which the RFID reader 202 in question is installed by referring to the database. In addition, the monitoring device 100 shoots the person by a monitoring camera 221 near the RFID reader 202 in question. Then, the monitoring device 100 executes processing according to a mode corresponding to severity of the situation.

A first mode is in the case where a person in question comes to a standstill and stops after an elapse of 2 seconds. In this case, a large number of relevant persons in the work facility can be prevented from panicking, and they can safely evacuate without accidents.

In a second mode, when a suspicious person does not leave even after 5 seconds from a warning by sound, the monitoring camera 221 is set in a direction toward a position of the suspicious person and shoots the suspicious person. Safety of relevant persons in the work facility can be ensured.

In a third mode, when the suspicious person does not leave even after, for example, 10 seconds from the warning by sound, a report is made to relevant authorities. Information extraction from the work facility is prevented, accuracy of the suspicious person information is improved, and misidentification is prevented, and company relevant persons can make a report to and collaborate with relevant authorities.

The number of modes and times of the first to third modes can be arbitrarily set according to importance.

(5) Evacuation Guidance

The monitoring device 100 transmits, to the portable devices 300 of relevant persons, a 1st-floor entrance/exit, evacuation stairway, and passageway that are highly safe and distant from the position of R3 where a suspicious person is, by e-mail. The relevant persons can directly evacuate store visitors to the 1st-floor entrance/exit and the evacuation stairway that are highly safe and distant from the suspicious person.

The monitoring device 100 broadcasts on the monitors 222 installed in the work facility. A response can be safely made with high accuracy.

A method of operating the digital smart safety system 1000 in case of an accident or incident in an office, a research and development office, or a factory is described.

### APPLICATION EXAMPLE 4

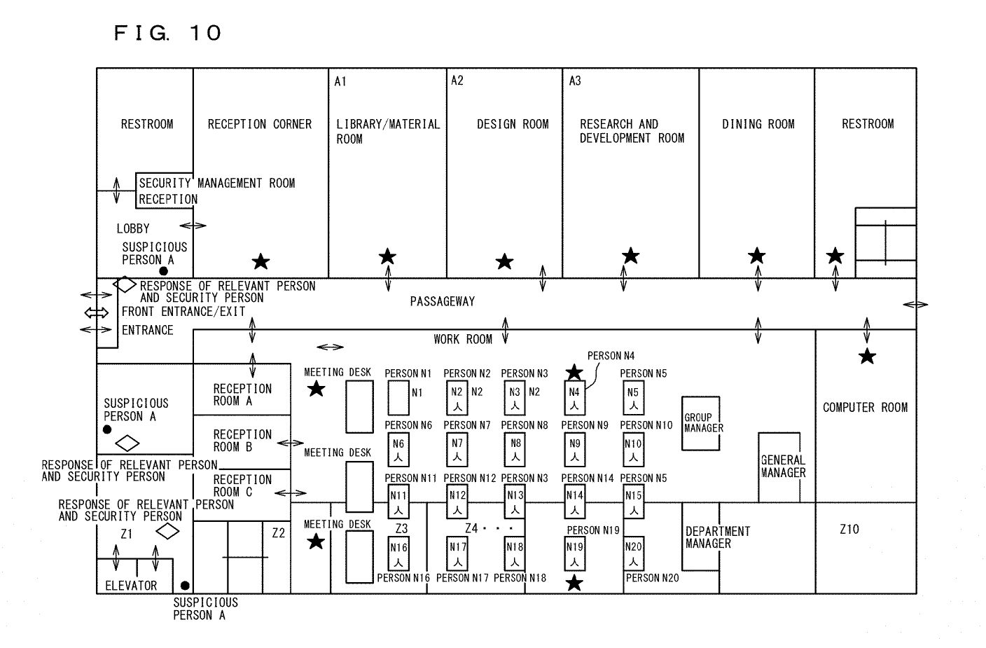

FIG. 10 shows an office or research and development office. As shown in FIG. 10, an office or research and development office includes work areas such as a restroom, a public room, a work room, a research and development room, a design room, a material room, and a customer information room, etc.

(1) RFID

The monitoring device 100 stores permitted areas, room names, days, and times as authorized content in the database.

An authorized relevant person R10 (not shown) can act and work in, for example, the whole facility and the whole public room such as the restroom, etc. An authorized relevant person R11 (not shown) can act and work at a time and on a day determined for work in work areas including the work room, the research and development room, the design room, the material room, and the customer information room, etc.

When a relevant person does not carry an RFID tag (authentication card 31) with him/her or is unauthorized, the monitoring device 100 automatically issues a warning by sound by using the speaker 223 near the RFID reader 202 at the position where the person in question is. In this case, in order to prevent misidentification, a delay time is set.

(2) When a Result of Authentication is a Mismatch

In a first mode, when a person in question does not leave after 5 seconds, sound and an image are transmitted to the portable devices 300 of relevant persons by e-mail. The relevant persons can respond to the site in real time. A number of relevant persons in the work facility can thus safely evacuate while preventing a panic without accidents.

In a second mode, when the suspicious person does not leave even after an elapse of 10 seconds from the warning by sound, the monitoring camera 221 is set in a direction toward a position of R3 in the block Z3 in which the suspicious person is and shoots the intruder. Safety of relevant persons in the work facility can be ensured.

In a third mode, when the suspicious person does not leave even after 15 seconds from the warning by sound, a layout showing R3 at the position in question is transmitted to relevant authorities. By making a report to the relevant authorities, collaboration with the relevant authorities can be made. Safety of relevant persons in the work facility can be ensured, misidentification can be prevented, and accurate information can be transmitted.

The number of modes and times of the first to third modes can be arbitrarily set according to importance.

(3) Evacuation Guidance

The monitoring device 100 transmits, by portable devices 300 of relevant persons, a 1st-floor entrance/exit, evacuation stairway, and passageway that are highly safe and distant from the position of R3 where the suspicious person is, by e-mail. The relevant persons can directly evacuate store visitors to the 1st-floor entrance/exit and evacuation stairway that are highly safe and distant from the suspicious person.

In addition, the monitoring device 100 broadcasts on the monitors 222 installed in the work facility. A response can be safely made with high accuracy.

(4) Relevant Person Not Authorized to Enter or Exit from Research and Development Room

A relevant person K20 (not shown) or external maintenance contractor is not authorized to enter a research and development room of an important facility. When the relevant person K20 tries to enter the research and development room R4 area other than the permitted areas, in a case where a radio wave does not match the RFID reader 202 or the relevant person does not carry an RFID tag, the monitoring device 100 extracts the floor number, area, and layout in which the RFID reader 202 in question is installed by referring to the safety-related information storage DB 135. In addition, the monitoring device 100 shoots the person by the monitoring camera 221 near this RFID reader 202. Then, the monitoring device 100 executes processing according to a mode corresponding to severity of the situation.

In a first mode, when the person in question comes to a stand and stops after an elapse of 2 seconds, a warning is issued by sound. In this case, a large number of relevant persons in the work facility can be prevented from getting panicking, and can safely evacuate without accidents.

In a second mode, when the suspicious person does not leave even after 5 seconds from the warning by sound, the monitoring camera 221 is set in a direction toward a corresponding position where the suspicious person is and shoots the suspicious person. Safety of relevant persons in the work facility can be ensured.

In a third mode, when the suspicious person does not leave even after, for example, 10 seconds from the warning by sound, a report is made to relevant authorities. Information extraction from the work facility is prevented, accuracy of suspicious person information is improved, and misidentification is prevented, and company relevant persons can make a report to and collaborate with relevant authorities.

The number of modes and times of the first to third modes can be arbitrarily set according to importance.

Permission and non-permission according to RFID authentication are described above by way of example, however, the same authentication can be performed by using iBeacon.

### APPLICATION EXAMPLE 5

When a radio wave of an iBeacon slave device 203 and a radio wave of a portable device 300 do not match, or when a person does not carry the portable device 300 with him/her, the monitoring device 100 transmits sound and an image to portable devices 300 of relevant persons by e-mail.

When K5 (not shown) comes to a standstill and stops at a place for K3 (not shown), and K3 is absent, an iBeacon slave device 203 at the place for K3 transmits a radio wave and the portable device of K5 receives the radio wave of the iBeacon slave device 203, and the monitoring device 100 determines a mismatch radio wave.

In a first mode, K5 transmitting a mismatch radio wave of K5 comes to a standstill at the position of the iBeacon slave device 203, and three seconds elapse. The monitoring device 100 turns OFF the switch of the relay box 225 of a PC accessible to confidential data to cut-off power supply. K5 cannot access this PC. K3 can be prevented from illegally extracting and using highly confidential information, and information leakage, etc., can be prevented.

In this case, the monitoring device 100 may turn ON the electric locks 226 of the desk, document cabinet, etc., of K3 to lock the desk, document cabinet, etc. In addition, the switch of the relay box 225 of the electric lock 226 of an entrance door of an important room such as a server room, a client information room, or a research and development room, may be turned ON to prevent K5 from entering the room. Extracting and copying, etc., of a document of K3 as an unauthorized act of K5 can be prevented in real time.

In a second mode, when K5 does not leave even after 3 seconds elapse from a warning by sound, a position of K5 is shot by the monitoring camera 221 to take an image of K5 (intruder). An unauthorized act of K5 in the work facility can be more reliably prevented.

In a third mode, when K5 does not leave even after 5 seconds from the warning by sound, a layout image of the position in question is transmitted to relevant authorities and collaboration with the relevant authorities is made. Safety of relevant persons in the work facility can be ensured, misidentification is prevented, and accurate information can be transmitted.

In a fourth mode, after 10 seconds, in order to enable direct evacuation to a 1st-floor entrance/exit and an evacuation stairway that are highly safe and distant from the position of the intruder K5, a passageway for evacuation is broadcast on the monitors 222 installed in the work facility. A response can be safely made with high accuracy.

The number of modes and times of the first to fourth modes can be arbitrarily set according to importance.

### APPLICATION EXAMPLE 6

The digital smart safety system 1000 can be applied to the following works by being connected to a LAN.

It is assumed that there are works to be performed by K1 as a head of work, a section manager K2, a group manager K3, and persons in charge K4 to K200. When a person in charge cannot come to work due to an unexpected reason such as sick leave, if there is work to be performed by someone instead, the digital smart safety system 1000 prevents information leakage, extraction, and copying, etc., by connection to a network constituting a LAN. The monitoring device 100 is connected to a constructed LAN. Work content of K1 to K200 are input in the database of the monitoring device 100. When accessing a network and an external connection storage device necessary for work, permission/non-permission of accesses to work contents, responsibilities, and sites, etc., of K1 to K200 are determined in advance by the other party. Access and connection to the other party, work content and sites other than those permitted cannot be made due to non-permission.

In the digital smart safety system 1000, regarding connection to the other party, work content, and sites in an external network or storage device necessary for work, access ranges that the relevant person K3 and the PC of K3 can access are determined according to permitted matters.

For example, for a reason of sick leave or a business trip, when work of K3 is quickly turned over by another person K2, upon approval by a management supervisor K1 and permission by a management authorized person ZK, the monitoring device 100 permits registration in the management PC of K3. The monitoring device 100 in this case may be installed as a function unit that performs digital smart safety control in a total work management PC. Person collation is performed by using the portable device 300 of K2. In addition, an unauthorized act and information copying and leakage, etc., are input into the monitoring device 100.

First, a radio wave transmitted by iBeacon at the place for K3 is received by the portable device 300 of K2, and the monitoring device 100 permits a work using the PC, desk, and document cabinet of K3 at the place for K3.

Next, a radio wave transmitted by iBeacon at the position of i3 is received by the portable device 300 that K2 carries with him/her. The monitoring device 100 makes the monitoring camera 221 shoot K2 while following action of K2. A close-up image of the situation where K3 opens the PC screen, the desk, and the document cabinet to take-out and access a document is taken.

Next, the monitoring device 100 determines permission/non-permission of the work that K2 did at the place for K3 by collating all records of date, day, time, the desktop and my document folders, files, mails, accesses to the Internet and USB memories of the PC of K3, and facsimile.

The monitoring device 100 executes processing according to a mode corresponding to severity of the situation.

In a first mode, the monitoring device 100 transmits a signal, and after 2 seconds, displays a warning on the screen. By transmitting a non-permission signal by the monitoring device 100 and displaying an elapse of time in units of seconds on a warning screen after issuing an alert, an erroneous report due to an operation error of the PC is prevented, and an input of accurate information can be facilitated.

In a second mode, the monitoring device 100 transmits a non-permission signal, and after 3 seconds, a warning is issued on the PC screen in question. When an operation such as an unauthorized act is still continuously performed, the portable device 300 of K2 is made to receive a radio wave of the iBeacon i3 of K3 at the position of K2. The monitoring device 100 determines that K2 is performing an operation on the KPC at the place for K3 as an unpermitted behavior. By issuing a warning by sound with the installed speaker 223, safety of relevant persons in the work facility is ensured. The monitoring device 100 transmits a layout image of the position where K2 is to the portable device 300 of a management personnel by e-mail. Safety of relevant persons in the work facility is ensured, misidentification is prevented, and accurate information can be transmitted. The management personnel makes confirmation by e-mail, image, and layout in real time, and can respond to the position where K2 is and prevent an unauthorized act. It is also possible that a warning by sound is canceled, and the management personnel responds to the site and catches K2, and questions K2.

In a third mode, the monitoring device 100 transmits a non-permission signal, and after 3 seconds, issues a warning on the PC screen in question. When the operation being the unauthorized act is still continuously performed, if an external storage device is accessed, a warning is issued, and after 1 or 2 seconds from setting of the warning, by turning OFF the switch of the relay box 225, the power supply to the PC is cut off. Similarly, when an unauthorized access to the network is made, the monitoring device 100 issues a warning, and after 1 or 2 seconds from setting of the warning, by turning OFF the switch of the relay box 225, a power supply of a network hub 242 that is an information entrance/exit of the network is cut off. An unauthorized access to the external storage device and the network can be prevented, and information leakage and copying, etc., can be prevented.

In a fourth mode, the monitoring device 100 transmits a non-permission signal, and after 5 seconds, unless an unauthorized access is canceled, an unauthorized person or K2 is determined to be a convinced criminal, and a shutdown signal is transmitted to the PC server 241 in question via the LAN. Accordingly, the PC server 24 can be forcibly shut down to prevent an unauthorized act such as information leakage, extraction, and copying, etc.

At the same time, the monitoring device 100 transmits a non-permission signal, and after 4 seconds, the switch of the relay box 225 of a power supply device of the electric lock 226 installed in each of the desk and the document cabinet of K3 is turned ON, and the desk and the document cabinet , etc., are locked.

At the same time, in the monitoring device 100, the electric lock 226 is also installed in entrance/exit doors of important rooms such as the server room, the customer information room, and the research and development room. The switch of the relay box 225 of the electric lock 226 is turned ON, the electric lock 226 performs locking, and K5 or a suspicious person cannot enter the room, so that extracting and copying, etc., of a document of K3, being an unauthorized act by K5, can be prevented in real time.

In a fifth mode, the monitoring device 100 transmits a non-permission signal, and when K2 or another suspicious person is still at the place for K3 and does not cancel the unauthorized access to the network, the external storage device, etc., even after 5 seconds from the shutdown of the PC server 241, an OFF signal is transmitted to the switch of the relay box 225 connected to the power supply of the PC server 241 in question to forcibly cut off the power supply of the PC server 241. All unauthorized acts such as information leakage, extraction, and copying from the PC server 241 can be prevented. The above-described time after the shutdown may be arbitrarily properly set. Here, all information in the PC server 241 in question are input and stored in advance in the monitoring device 100, so that even after the power supply is forcibly cut off, work content that K3 did and unauthorized operations of K2 are all stored. Even when the power supply is forcibly cut off , no problem occurs. It is also possible that, according to a status of use by a business operator, a warning against unauthorized acts with respect to the external storage device and network of the PC server 241 is issued, and for example, after 1 second, the PC server 241 is shut down, and then, after 2 or 3 seconds, the PC power supply is cut off.

### APPLICATION EXAMPLE 7

### (Runaway of Suspicious Person)

By receiving a radio wave transmitted by iBeacon of K2 by the portable device 300 that K2 carries with him/her, the monitoring device 100 determines that K2 is on the run at the position of K2. The monitoring camera 221 at the position of K2 shoots K2, and the monitoring device 100 transmits the image, position, and layout, etc., to the portable devices 300 of relevant persons. The relevant persons can respond to the site and catch K2 or a suspicious person. When K2 or the suspicious person throws his/her RFID tag and portable device 300 away to avoid pursuit as a runaway, the motion sensor 211 installed in the facility detects this, and the monitoring device 100 transmits an image, position, and layout, etc., relating to the behavior of K2 or suspicious person to portable devices 300 of relevant persons. In this case, a message informing that this suspicious person is on the run after throwing his/her RFID tag and portable device 300 away may also be transmitted. The relevant persons can respond to the site and more quickly catch K2 or the suspicious person.

When the suspicious person or K2 runs away in a direction toward K4 and K5, a radio wave of the iBeacon or a corresponding installed sensor works. The monitoring device 100 turns the monitoring camera 221 to a next runaway direction toward K5 and K6 to shoot this direction. The monitoring device 100 transmits a layout of K5 to K6 to the portable devices 300 of the relevant persons. The relevant persons can make an appropriate response.

### APPLICATION EXAMPLE 8

(Utilization of iBeacon)

In the digital smart security system 1000, each of iBeacons and portable devices 300 installed in the work facility normally transmits/receives a radio wave by approximately 10 cm to 5 m. With respect to each distance of reception of a radio wave transmitted from the iBeacon by the portable device, the following processing is performed.

(1) iBeacon master devices 302 are numbered, and installed in work rooms, important departments, and at positions where relevant persons work in the facility in question. The monitoring device 100 stores a layout chart of the work facility in question, positions where all relevant persons K1 to K200 respectively work, and phone numbers of the portable devices 300 of the relevant persons K1 to K200 in the safety-related information storage DB 135.

The following equipment are installed at positions where all relevant persons K1 to K200 respectively work.

The iBeacon is installed at important positions including a PC power supply device, desk drawers, document cabinet doors, entrance/exit doors of the server room, the design room, and the customer information room, etc.

Among iBeacons i1 to i200 installed at the respective positions of all relevant persons K1 to K200 and the portable devices S1 to S200 of all relevant persons K1 to K200, the iBeacon i3 makes transmission. The portable device 300 receives a radio wave of the iBeacon of K3, and the monitoring device 100 inputs and collates this. A radio wave of the iBeacon i3 is determined as an appropriate radio wave of K6.

According to an elapse of time from an inappropriate radio wave at a position where the external or in-company suspicious person described above works, a large number of relevant persons being in the work facility raise the level of security specifications by setting the first to fifth modes.

In response to an unpermitted behavior, the monitoring device 100 issues a warning by showing the position, sound, layout, and image of the suspicious person. Communications with the portable devices 300 of relevant persons are made, and the relevant persons can make a response in real time and prevent a theft and information extraction, etc.

In the digital smart safety system 1000, the relevant persons K1 to K200 whose workplaces are determined use a PC, desk, and document cabinet at the place for K1=S1, K2=S2, K3=S3, . . . , K200=S200. K1=S1, K2=S2, and K3=S3 are determined as appropriate radio waves, and the following modes are used.

In a first mode, after an elapse of 2 seconds, when the suspicious person comes to a standstill and stops, a warning is issued by sound. A large number of relevant persons being in the work facility can safely evacuate without panic and accidents.

In a second mode, the switch of the relay box 225 of the PC power supply device is turned OFF, and the power supply of the PC is cut off.

In a third mode, when the suspicious person does not leave even after 5 seconds from the warning by sound, a position where the suspicious person is is shot by the monitoring camera 221. Safety of relevant persons being in the work facility can be ensured.

Ina fourth mode, when the suspicious person does not leave even after 10 seconds from the warning by sound, the monitoring device 100 transmits a layout image showing R3 at the position in question to company relevant persons, and collaborates with relevant authorities. Information extraction from the work facility can be prevented, and accuracy of information on the suspicious person and prevention of misidentification are realized.

(4) In the fourth mode described above, evacuation guidance control (refer to FIG. 4 and FIG. 5) can also be performed.

In the evacuation guidance control , in order to enable direct evacuation to a 1st-floor entrance/exit and an evacuation stairway that are highly safe and distant from the position of R3 where the suspicious person is, a passageway is shown and broadcast on the monitors 222 installed in the work facility. A response can be safely made with high accuracy.

Utilization of iBeacon is described above, and iBeacon can be used in combination with RFID readers 202 installed in the work facility. The RFID readers 202 in the work facility detect at a distance of approximately several meters to 20 m, and the iBeacons detect at a distance of approximately 10 cm to 5 m, and whether a person in this distance space is proper or abnormal can be determined.

### APPLICATION EXAMPLE 9

### (Accident/Incident in Business Facility)

A method of operating the digital smart safety system 1000 in case of an accident/incident in a business facility is described.

As shown in FIG. 9, in the business facility, various sensors, laser radars 212, monitoring cameras 221, microphones 224, loudspeakers, floodlights, sprays, etc., are installed. In addition, there are rooms for respective back offices, an office room, an accounting room, passageways, a cargo handling yard, a kitchen, a restroom, and a warehouse, etc. According to a building shape and scale, the facility is divided into, for example, blocks Z1B, Z2B, and Z3B to Z250B by horizontal axes X1, X2, and X3 to X7 and vertical axes Y1, Y2, and Y3 to Y9.

In case of emergency of an accident/incident, a position where an intruder is is detected by, for example, a motion sensor 211, and shot by the monitoring camera 221.

In a first mode, a warning is automatically issued by sound in real time, and a layout image of the position where the intruder is is transmitted to aportable device 300 of a relevant person near the intruder. A number of facility visitors and relevant persons can safely evacuate without panic and accidents.

In a second mode, when the intruder does not leave after 3 seconds from the warning, the position of the intruder is shown in the layout and transmitted to a portable device 300 of a security-related person. The security-related person reports an accurate status of the intruder to relevant authorities and responds to the site while looking at the transmitted image.

In a third mode, when the intruder does not leave after 5 seconds from the warning, the installed floodlights and spray work, and the position in question is shown in the layout and transmitted to a portable device 300 of a security-related person. The security-related person can report an accurate status of the intruder to relevant authorities while looking at the image.

In a fourth mode, when the intruder does not leave after 8 seconds from the warning, from a back area, a position of the intruder and a position of the sensor that detected the intruder are determined.

In a fifth mode, when the intruder does not leave after 10 seconds from the warning, relevant persons are evacuated to the safe outdoors from the back area. It is preferable that an evacuation route is as short as possible and a traffic line is clear.

In the present embodiment, the monitoring device 100 outputs an optimum route from route information stored in advance in the safety-related information storage DB 135. For example, the monitoring device 100 stores in the safety-related information storage DB 135, entrances/exits, stairways, evacuation facilities, etc., positions of motion sensors 211 installed in rooms, chambers, stairways in the respective blocks, disposition information of the entrances/exits, stairways, and evacuation facilities, etc., and traffic distances that people move through these areas. The monitoring device 100 determines a position of the motion sensor 211 that detected a position of the intruder. Evacuees can evacuate in case of emergency.

The monitoring device 100 performs evacuation guidance control to guide evacuation to a place that is highly safe and distant from the position of R20 where the intruder is. For example, evacuation is guided to the entrances/exits 1 to 12, stairways 1 to 12, and evacuation facilities 1 to 8 that are on the side opposite to and distant from the position of R20 where the intruder is. The monitoring device 100 transmits a layout that enables quick evacuation to the safe outdoors and an image of the intruder to the portable devices 300 of relevant persons. The relevant persons in the back area can safely evacuate and the relevant persons can properly guide evacuation of store visitors. The monitoring device 100 broadcasts the content (evacuation route, etc.) on the monitor 222 installed in the back area. By broadcasting on the monitor 222, the relevant persons can be more safely evacuated.

### APPLICATION EXAMPLE 10

### (Prevention of Accident/Incident in Business Facility)

The digital smart safety system 1000 ensures the security in a business area such as a commercial facility, a complex facility, an underground mall, a station building, a terminal facility, a financial facility, a stadium, and a ship facility, etc.

In order to ensure the security in such a business facility, it is preferable to report a detailed status of a person on a blacklist who has had an accident in a company in question, such as acting in an irregular way or shoplifting, to security-related persons and relevant authorities. That is, it is preferable to ask for cooperation of security-related persons and relevant authorities. By reporting a detailed status to security-related persons and relevant authorities, if an accident/incident should occur in the facility, a safer evacuation guidance of store/facility visitors and relevant persons and finding a suspicious person and pursuit of his/her behavior become more effective. In addition, a greater-detailed status can be reported to security-related persons and relevant authorities.

For this, in the business facility, Wi-Fi slave devices 201, RFID readers 202, iBeacon slave devices 203, motion sensors 211, Doppler sensors (not shown), laser radars 212, monitoring cameras 221, monitors 222, microphones 224, loudspeakers, floodlights, and sprays, etc., are installed. In addition, relevant persons who carry portable devices 300 with them are made to wear pressurized safety systems 310.

When there are sales areas, sales corners, valuable item sales areas, passageways, stairways, evacuation facilities, emergency elevators, and entrances/exits, etc., on each floor of the business facility, according to the building shape and scale, the facility is divided into blocks Z1B, Z2B, and Z3B to Z250B by horizontal axes X1, X2, and X3 to X7 and vertical axes Y1, Y2, and Y3 to Y9.

While the business facility is open, an unspecified number of store/facility visitors are in the facility, and it is very important to detect an accident/incident before it occurs.

Monitoring cameras 221 that can recognize humans are installed at the entrances/exits, passageways, top and bottom of stairways, elevator (ELV) doorways, sales areas, sales corners, and valuable item sales areas, etc. A person on a blacklist who has acted in an irregular way such as repeated passage through the same sales area or passageway in the business facility or shoplifting and an accident in the corresponding company or facility before, is found.

Authorized relevant persons carry RFID tags with them . When a person on a blacklist or a suspicious person A repeatedly visits and passes through the business facility to check where the relevant persons K1 to K200 work, the monitoring cameras 221 shoot the suspicious person and the monitoring device 100 determines the suspicious person. For example, the monitoring device 100 transmits a layout, etc., showing a floor number, sales area name, and sales area corner including the position where the suspicious person A is to the portable devices 300 of relevant persons by e-mail.

The relevant person K7 near the position of the suspicious person A meets with the suspicious person and says “Hello. May I help you?.” An incident such as shoplifting can be prevented.

### APPLICATION EXAMPLE 11

### (Evacuation Guidance in Case of Serious Accident/Incident in Business Facility)

An emergency situation where a plurality of store visitors B, C, and D present deadly weapons and try to rob valuable items and financial merchandise from a sales area in the block Z3 on the 3rd floor of a business facility, is described.

In the case of emergency, a relevant person who meets with these persons activates the pressurized safety system 310 and transmits an emergency signal by the transmitting/receiving function of Bluetooth. The portable device 300 transmits an emergency signal to the monitoring device 100 of the digital smart safety system 1000.

The monitoring device 100 receives the emergency signal and shifts to emergency situation control. In detail, the monitoring camera 221 installed in the valuable item sales area in the block Z3 on the 3rd floor is activated to shoot the criminal persons B, C, and D, and the microphone 224 picks up conversation between the criminal persons and the relevant person.

The monitoring device 100 transmits a layout showing the valuable item sales area in the block Z3 on the 3rd floor, image, and sound to the portable devices 300 of other relevant persons by e-mail. Other relevant persons can report the occurrence of the emergency situation to security-related persons and relevant authorities. A number of store visitors can safely evacuate without panic and accidents.

Mode-response control in case of emergency is as follows.

In a first mode, the pressurized safety system 310 is activated to transmit a signal, and after 5 seconds, an image is broadcast on the monitors 222 installed in the valuable item sales area in the block Z3 and passageway on the 3rd floor where the incident has occurred. In addition, the monitoring device 100 transmits an image and sound of the criminal persons B, C, and D to the portable devices 300 of relevant persons.

In order to ensure customers' safety, for example, the monitoring device 100 performs the following control.

The blocks Z4 to Z7 on the side opposite to the block Z3 including the position of the intruders are measured and input, and a layout chart clearly showing a stairway and an entrance/exit of an evacuation facility that are highly safe and distant from the position of the intruders is transmitted. In this case, a two-split moving image including a moving image A of a wide range, obtained by shooting the criminal persons B, C, and D, is displayed. In the two-split moving image , a moving image B obtained by shooting the criminal persons close up is a moving image showing the status of the intruders in the block Z3 that is an intrusion site. In addition, picked-up sound and an image of the intruders are transmitted to the portable devices 300 of relevant persons by e-mail. The relevant persons confirm them in real time, and can respond to the site and make a report to relevant authorities.

In a second mode, after 10 seconds from transmission of the signal of the pressurized safety system 310, a layout showing a stairway and an entrance/exit that are on the side opposite to and distant from the valuable item sales area in the block Z3 on the 3rd floor and passageways are broadcast on the monitors 222. The monitoring device 100 also transmits the same image to the screen of a PC server of the relevant persons K1 to K200 who carry RFID readers 202 with them. These relevant persons can safely and quickly instruct a guidance for store visitors near them.

In a third mode, after 20 seconds from transmission of the signal of the pressurized safety system 310, the monitoring camera 221 installed in the runaway direction in which the criminal persons B, C, and D ran away from the valuable item sales area in the block Z3 on the 3rd floor (herein, the monitoring camera 221 in the block Z2, set in the direction toward the 2nd-floor stairway), shoots the criminal persons B, C, and D.

In a fourth mode, after 25 seconds from transmission of the signal of the pressurized safety system 310, the monitoring camera 221 in the runaway direction in which the criminal persons B, C, and D ran away (here, the monitoring camera 221 in the block Z2, set in the direction toward the 2nd-floor stairway), shoots the criminal persons B, C, and D.

In a fifth mode, after 30 seconds from transmission of the signal of the pressurized safety system 310, a layout of a stairway and an entrance/exit in a direction against the criminal persons B, C, and D in the block Z2, and passageways are broadcast on the monitor 222.

In addition, a video of the criminal persons is displayed on the PC screens at the positions of the relevant persons K1 to K200 who carry RFID readers with them. These relevant persons can safely and quickly instruct a guidance for store visitors near them.

By the process described above, relevant persons can safely and quickly evacuate to a stairway and an entrance/exit that are on the side opposite to the criminal persons B, C, and D positioned in the block Z2 and found to be distant from the criminal persons as a result of measurement, without accidents.

### APPLICATION EXAMPLE 12

### (Arrest of Criminal Persons in Serious Accident/Incident in Business Facility)

Subsequently, when the criminal persons B, C, and D run away from the block Z2 to the blocks Z3 to Z6, control leading to the arrest of the criminal persons is performed.

The monitoring device 100 turns the monitoring camera 221 toward the next blocks Z7 and Z8 to which the criminal persons B, C, and D will run away and shoots their front appearances, and transmits a moving image of the front appearances shot by the monitoring camera 221 and a corresponding layout to the portable devices 300 of relevant persons.

The monitoring device 100 broadcasts an image of a layout chart clearly showing a stairway and an entrance/exit of an evacuation facility that are distant from the criminal persons B, C, and D and highly safe. Store visitors being in the blocks Z7, Z8, and Z9 toward which the criminal persons B, C, and D run away, can keep a separation distance to the criminal persons B, C, and D, and safely and quickly evacuate in an opposite direction .

The monitoring device 100 broadcasts a moving image showing the status of the intruders on the monitor 222. For example, a two-split image consisting of a moving image A of a wide range obtained by shooting the criminal persons B, C, and D and a moving image B obtained by shooting the criminal persons close up is broadcast. The relevant persons can give a guidance in a safe direction by looking at the e-mail, the layout chart, and the moving image transmitted to the portable devices 300.

The monitoring device 100 broadcasts a passageway that is on the side opposite to the position of the criminal persons B, C, and D and highly safe, on the monitor 222. A nearby relevant person can safely guide store visitors. Store visitors can directly evacuate to the 1st-floor entrance/exit and the evacuation stairway that are on the side opposite to the position of the criminal persons B, C, and D and highly safe.

As described above, according to the present embodiment, in the digital smart safety system 1000, the monitoring device 100 of the digital smart safety system 1000 comprises a control unit 110 and a safety-related information storage DB 135, and the safety-related information storage DB 135 stores safety-related information including installation locations of the smoke detectors 234. The control unit 110 comprises a smoke determination means 112 that determines a flow direction, volume and speed of smoke based on smoke information detected by a plurality of smoke detectors 234 installed at various positions in the facility, a fire door detection means that detects a fire door/fire shutter 228 installed in the facility is not closed, a human detection means 114 that, in case of fire, detects a person who has failed to escape, a control means 115 that designates a safe place based on the results of determination by the smoke determination means 112 and performs evacuation guidance control to guide evacuation of facility relevant persons, and a transmission control unit 116.

Accordingly, a flow direction, volume and speed of smoke can be detected and a safe place is designated and guidance thereto is made, so that high-quality evacuation guidance to guide people in a direction of a smaller smoke flow is realized, and evacuation of people in the facility can be safely guided in case of fire.

In the present embodiment, smoke is diffused by the air blower 235 to openings such as windows and smoke vents around the exterior, so that by diffusion of smoke, smoke inhalation at the time of evacuation can be reduced.

In the present embodiment, a not closed state of the fire door/fire shutter 228 is detected and reported, so that people can know the not closed state of the fire door/fire shutter 228 and safely evacuate.

In the present embodiment, a person who has failed to escape is detected and reported, so that a communication channel for evacuation guidance of a person who has failed to escape increases, and the effect of the evacuation guidance can be improved.

The description described above is exemplification of a preferred embodiment of the present invention, and the scope of the present invention is not limited thereto. For example, in the present embodiment, a case where a phone line is used as a public line is described, however, the invention is not limited to this case, and for example, a wireless communication line, the Internet, a LAN, etc., may be used as a public line. Depending on the kind of public line, a transceiver may be used as a communication terminal device when the public line is a wireless communication line, and a personal computer or a palm-top computer may be used as a communication terminal device when the public line is the Internet or a LAN. In this way, by constructing the digital smart safety system by using the existing public line, the usage pattern of the digital smart safety system can be expanded, and the construction cost of the digital smart safety system can be reduced.

In the present embodiment, the title “digital smart safety system and method” is used for the sake of description, and the title may be changed to “digital smart security, a crime prevention system, a security method, etc.”

Further, detection of an abnormal situation includes detection of all known abnormal situations. For example, abnormal situations are intrusion or approach of a suspicious person. A report may be made in any form without limiting to e-mail.

The digital smart safety system and method of the present invention are also realized by a program to operate a computer as the present digital smart safety system or method.

This program may be stored in a storage medium that can be read by a computer.

This storage medium recorded with the program may be a ROM itself of the present digital smart safety system, or may be a storage medium such as a CD-ROM that can be read, when a program reading device such as a CD-ROM drive is provided as an external storage device, by inserting the storage medium therein.

Moreover, the above-described storage medium may be a magnetic tape, a cassette tape, a flexible disk, a hard disk, an MO/MD/DVD, etc., or a semiconductor memory.

### INDUSTRIAL APPLICABILITY

A digital smart safety system, method, and program according to the present invention work in real time in corporate/commercial facilities and offices, etc., and prevent losses of property and life and economic losses, and an usage effect thereof is significant.

### REFERENCE SIGNS LIST

31 Authentication card (RFID tag)
100 Monitoring device
110 Control unit
111 Relevant-person-position information acquisition means
112 Smoke determination means
113 Fire door detection means
114 Human detection means
115 Control means
116 Transmission control unit
120 Input unit
130 Storage unit
135 Safety-related information storage database (DB) (part of smoke determination means)
140 Display unit
150 Output unit
160 Face information database (DB)
170 Image processing unit
180 Interface (I/F) unit
190 Communication unit
200 Safety-related device
201 Wi-Fi terminal (Wi-Fi slave device) (part of human detection means)
202 RFID reader (part of human detection means)
203 iBeacon slave device
211 Motion sensor
212 Laser radar
221 Monitoring camera
222 Monitor
223 Speaker
224 Microphone
225 Relay box
226 Electric lock
228 Fire door/fire shutter
232 Mechanical smoke vent
233 CO detector
234 Smoke detector (smoke detection means)
235 Air blower
300 Portable device
301 Wi-Fi individual identification device (Wi-Fi master device) (part of human detection means)
302 iBeacon master device
303 GPS
1000 Digital smart safety system

1. A digital smart safety system comprising:
a safety-related information storage means configured to store safety-related information including a layout of a facility;
smoke detection means configured to output smoke information after detecting smoke from a fire in the facility;
a smoke determination means configured to perform a determination based on the smoke information whereby the determination ascertains a flow direction of the smoke, volume of the smoke and speed of the smoke; and
a control means configured to designate a safe place based on a result of the determination and to perform evacuation guidance control that will guide an evacuation of a person relevant to the facility.

2. The digital smart safety system according to claim 1, further comprising:
an air blower situated at windows or smoke vents around an exterior of the facility, the air blower is controllable by the control means to diffuse the smoke by blowing air in an air blowing direction after the smoke has been detected or during the evacuation guidance control, wherein
the air blowing direction is based on a result of the determination.

3. The digital smart safety system according to claim 1, further comprising:
fire door detection means configured to perform a detection that ascertains whether or not a fire door in the facility is closed, wherein
based on results of the detection, the control means is configured to report whether or not the fire door in the facility is closed to the person.

4. The digital smart safety system according to claim 1, further comprising:
human detection means configured to detect a person who has failed to escape in case of the fire, wherein
the control means is configured to report the existence of the person who has failed to escape based on results of detection by the human detection means.

5. A digital smart safety method comprising:
a safety-related information storing step of storing safety-related information including a layout of a facility;
a smoke detecting step of detecting smoke from a fire, installed in the facility;
a smoke determination step of determining a flow direction, volume and speed of smoke based on smoke information detected in the smoke detecting step; and
a control step of performing evacuation guidance control to designate a safe place based on results of determination in the smoke determination step, and guide evacuation of a person relevant to the facility.

6. (canceled)

7. A tangible non-transitory computer-readable storage medium, the computer-readable storage medium is configured to store a program executable by a digital smart safety system, the digital smart safety system upon execution of the program is configured to perform the method of claim 5.
